(19) United States
(12) Patent Application Publication
(10) Pub. No.: US 2016/0261375 A1
(43) Pub. Date: Sep. 8, 2016

(54) PACKET FORMAT AND CODING METHOD FOR SERIAL DATA TRANSMISSION

(71) Applicant: QUALCOMM Incorporated, San Diego, CA (US)

(72) Inventors: Wolfgang Roethig, San Jose, CA (US); Vidyut Naware, Sunnyvale, CA (US); Nitin Kasturi, Saratoga, CA (US)

(21) Appl. No.: 14/962,363

(22) Filed: Dec. 8, 2015

Related U.S. Application Data
(60) Provisional application No. 62/128,142, filed on Mar. 4, 2015.

(51) Int. Cl. H04L 1/00; H04L 7/04

(52) U.S. Cl. CPC H04L 1/0083; H04L 7/048

(57) ABSTRACT

A method, an apparatus, and a computer program product for data communication are provided. The method may include providing a frame of encoded data, generating a synchronization symbol to precede the encoded data when the frame is transmitted over a communication link, the synchronization symbol providing an identification of a type of the frame in accordance with an encoding scheme. The synchronization symbol may be encoded using a redundant coding scheme to support error correction for the identification of the type of frame. The frame may have a predefined fixed length.

### CROSS-REFERENCE TO RELATED APPLICATIONS

This application claims priority to and the benefit of U.S. Provisional Patent Application No. 62/128,142 filed Mar. 4, 2015, the entire content of which is incorporated herein by reference for all applicable purposes.

### TECHNICAL FIELD

The present disclosure relates generally to communication systems, and more particularly, to communications links connecting integrated circuit devices within an apparatus.

### BACKGROUND

Serial interfaces have become the preferred method for digital communication between integrated circuit (IC) devices in various apparatus. For example, mobile communications equipment may perform certain functions and provide capabilities using IC devices that include radio frequency transceivers, cameras, display systems, user interfaces, controllers, storage, and the like. General-purpose serial interfaces known in the industry, ranging between the Inter-Integrated Circuit (I2C) interface providing bandwidth measurable in kilobits per second (Kbps), and high bitrate interfaces such as the Peripheral Component Interconnect Express (PCI-E) with bandwidths measurable in gigabits per second (Gbps). Other examples are defined by industry standards such as the Ethernet standards that provide bandwidths of 10/100 megabits per second (Mbps), 1 Gbps, 10 Gbps, Universal Serial Bus (USB) standards that provide bandwidths between 1.5 Mbps and 10 Mbps, and multimedia standards such as standards and specifications defined by the Mobile Industry Processor Interface Alliance (MIPI) including the Display System Interface (DSI) and DigRF, standards defined by Electronic Industries Alliance (EIA) and/or the Consumer Electronics Association (CEA) including High-Definition Multimedia Interface (HDMI), and standards defined by the Video Electronics Standards Association (VESA) including DisplayPort.

The wide variety of such serial interface standards results from the broad-ranging requirements of a large number of different applications. Depending on the application, or generation of an application, a choice of the most suitable interface must be made. For example, the evolution of radio frequency (RF) technology from 3G to 4G to 5G presents challenges related to the integration of new capabilities in mobile device chipsets, such as chipsets for Long Term Evolution (LTE) and/or wireless local area network” (WLAN or WiFi), including in relation to cost, performance and power consumption constraints.

As the demand for improved communications between devices continues to increase, there exists a need for improvements in protocols and methods for managing the interfaces between such devices.

### SUMMARY

Certain aspects of the disclosure relate to systems, apparatus, methods and techniques for implementing and managing digital communication interfaces that may be used between IC devices in various apparatus. Some aspects may be at least partially expressed in protocols used to control communications between the IC devices. For example, one protocol may capitalize on tradeoffs between specifications for a physical coding sub-layer (PCS) and a link layer in order to achieve more efficient coding with increased resilience when bit errors occur.

In various aspects of the disclosure, a method may include providing a frame of encoded data, and generating a synchronization symbol to precede the encoded data when the frame is transmitted over a communication link. The synchronization symbol may provide an identification of a type of the frame in accordance with an encoding scheme. The synchronization symbol may be encoded using a redundant coding scheme to support error correction for the identification of the type of frame. The frame may have a predefined fixed length.

In one aspect, the encoded data has a length D and the synchronization symbol has a length S. The value of D may be selected to satisfy the condition D modulo M=0 where M is a natural number, and the value of S selected to satisfy the condition S+D modulo N=0 where N is a natural number. In one example, M=8 and N=10.

In one aspect, a first data packet may be encoded to obtain the frame of encoded data. The first data packet may include a header of fixed length, and payload data. The first data packet may include redundant data that provides for data integrity checking of at least a portion of the first data packet. The redundant data may include at least one of an error correction code for the header, an error correction code for the payload, or a checksum for the payload. The header may include an identification number indicating a type of the first data packet and metadata associated with the type of the first data packet.

In one aspect, encoding the first data packet includes encoding the first data packet into a number of frames determined based on size of the data packet, indicating a first frame as a starting frame of the number of frames using a first type of synchronization symbol, and indicating one or more frames as continuation frames using a second type of synchronization symbol that is different from the first type of synchronization symbol when one or more frames in addition to the first frame are used to encode the data frame.

In one aspect, encoding the first data packet includes encoding the first data packet into a plurality of frames, transmitting at least one of the plurality of frames on the communication link, encoding a second data packet into a single frame, the second data packet may include low latency or high priority data, transmitting the second data frame before the plurality of frames has been transmitted in its entirety on the communication link, and transmitting remaining frames of the plurality of frames after transmitting the second frame.

In one aspect, the header indicates that the payload includes configurable metadata. The method may include determining that the configurable metadata has changed, encoding a second data packet into a single frame, the second data packet may include the configurable metadata, and transmitting the second data frame as a high-priority frame.

In one aspect, providing the frame of encoded data includes encoding an ordered bit pattern to obtain a link control frame, and indicating the link control frame type of synchronization symbol different from synchronization symbols used to indicate data transmissions. Providing the frame of encoded data may include indicating the link control frame using a type of synchronization symbol that is different from synchronization symbols used to indicate data packet transmissions. The ordered bit pattern may have a minimum hamming distance of 4. The ordered bit pattern may include a DC-balanced bit pattern. The ordered bit pattern may include a high transition density. The ordered bit pattern may provide one or more indications to a receiver. The one or more indications may include an indication of alignment between a transmitter and the receiver. The one or more indications may include an indication of scrambling status information transmitted on a serial link. The one or more indications may include an indication of a transition between low-power and normal operational states.

In one aspect, the communication link includes a plurality of lanes. Providing the frame of encoded data may include providing a first frame of encoded data for transmission on a first lane of the communication link, the first frame encoding a first received portion of a data packet to be transmitted on the communication link, providing a second frame of encoded data for transmission on a second lane of the communication link, the second frame encoding a second portion of the data packet that is received immediately after the first portion. The first frame and the second frame may be transmitted concurrently on the communication link. Each subsequent portion of the packet of data may be allocated to a next-in-sequence lane. Providing the frame of encoded data may include providing a third frame of encoded data for transmission on a third lane of the communication link. The first, second, and third frames may be transmitted concurrently on the communication link.

In various aspects of the disclosure, an apparatus may be adapted to be coupled to a communication link, and may include a first encoder configured to encode data in frames, and a second encoder configured to generate a synchronization symbol for each frame, the synchronization symbol providing an identification a type of the frame in accordance with an encoding scheme, and a transmitter configured to transmit the frames to a receiver. Each frame may be preceded by its corresponding synchronization symbol. The synchronization symbol may be encoded using a redundant coding scheme to support error correction for the identification of the type of the frame. The frame may have a predefined fixed length.

In various aspects of the disclosure, an apparatus may have means for providing a frame of encoded data, and means for generating a synchronization symbol to precede the encoded data when the frame is transmitted over a communication link. The synchronization symbol may provide an identification of a type of the frame in accordance with an encoding scheme. The synchronization symbol may be encoded using a redundant coding scheme to support error correction for the identification of the type of frame. The frame may have a predefined fixed length.

In an aspect of the disclosure, a processor readable storage medium is disclosed. The storage medium may be a non-transitory storage medium and may store code that, when executed by one or more processors, causes the one or more processors to provide a frame of encoded data, and generate a synchronization symbol to precede the encoded data when the frame is transmitted over a communication link. The synchronization symbol may provide an identification of a type of the frame in accordance with an encoding scheme. The synchronization symbol may be encoded using a redundant coding scheme to support error correction for the identification of the type of frame. The frame may have a predefined fixed length.

In various aspects of the disclosure, a method performed at a physical layer of a communication interface in a receiving device includes receiving a frame of encoded data from a communication link, where the frame has a predefined fixed length, receiving a synchronization symbol associated with the frame of encoded data, and identifying a type of the frame based on the synchronization symbol. The synchronization symbol may be encoded using a redundant coding scheme that supports error correction for information in the symbol identifying the type of the frame.

In various aspects of the disclosure, an apparatus adapted to be coupled to a communication link includes a receiver configured to receive one or more frames from a transmitter using the communication link, each frame being preceded by a corresponding synchronization symbol, a first decoder configured to decode synchronization symbols that precede the frames, each synchronization symbol providing an identification a type of its corresponding frame in accordance with an encoding scheme, and a second decoder configured to decode data from each frame based on information provided by a corresponding synchronization symbol. The synchronization symbol may be encoded using a redundant coding scheme to support error correction for the identification of the type of the frame. The frame may have a predefined fixed length.

In various aspects of the disclosure, an apparatus has means for receiving a frame of encoded data from a communication link, where the frame has a predefined fixed length, receiving a synchronization symbol associated with the frame of encoded data, and means for identifying a type of the frame based on the synchronization symbol. The synchronization symbol may be encoded using a redundant coding scheme that supports error correction for information in the symbol identifying the type of the frame.

In an aspect of the disclosure, a processor readable storage medium is disclosed. The storage medium may be a non-transitory storage medium and may store code that, when executed by one or more processors, causes the one or more processors to a method performed at a physical layer of a communication interface in a receiving device includes receiving a frame of encoded data from a communication link, where the frame has a predefined fixed length, receiving a synchronization symbol associated with the frame of encoded data, and identifying a type of the frame based on the synchronization symbol. The synchronization symbol may be encoded using a redundant coding scheme that supports error correction for information in the symbol identifying the type of the frame.

### BRIEF DESCRIPTION OF THE DRAWINGS

FIG. 1 depicts an apparatus employing a data link between integrated circuit devices that selectively operates according to one of plurality of available standards.

FIG. 2 is a block diagram illustrating a device having a baseband processor and an image sensor and implementing an image data bus and a control data bus.

FIG. 3 is a diagram that illustrates an example of a system architecture for an apparatus employing a data link between IC devices according to certain aspects disclosed herein.

FIG. 4 is a diagram illustrating the Open Systems Interconnection (OSI) 7-layer model.

FIG. 5 illustrates the use of a set of multi-bit synchronization symbols to provide multiple transmission modes in a serial communication link between IC devices.

FIG. 6 is a state diagram illustrating PCS transmissions in accordance with certain aspects disclosed herein.

FIG. 7 is a packet timing diagram illustrating one example of a PCS frame structure.

FIG. 8 illustrates the format of a 2-byte header used in a data packet.

FIG. 9 is a block diagram illustrating an example of an apparatus employing a processing circuit that may be adapted according to certain aspects disclosed herein.

FIG. 10 is a first flow chart of a method of data communication.

FIG. 11 is a diagram illustrating an example of a hardware implementation for a transmitting apparatus employing a processing employing a processing circuit adapted according to certain aspects disclosed herein.

FIG. 12 is a second flow chart of a method of data communication.

FIG. 13 is a diagram illustrating an example of a hardware implementation for a receiving apparatus employing a processing employing a processing circuit adapted according to certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include a microprocessor, a microcontroller, a digital signal processors (DSP), an application-specific integrated circuit (ASIC), a field programmable gate array (FPGA), a programmable logic device (PLD), a state machine, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer.

Example of an Apparatus with Multiple IC Device Subcomponents

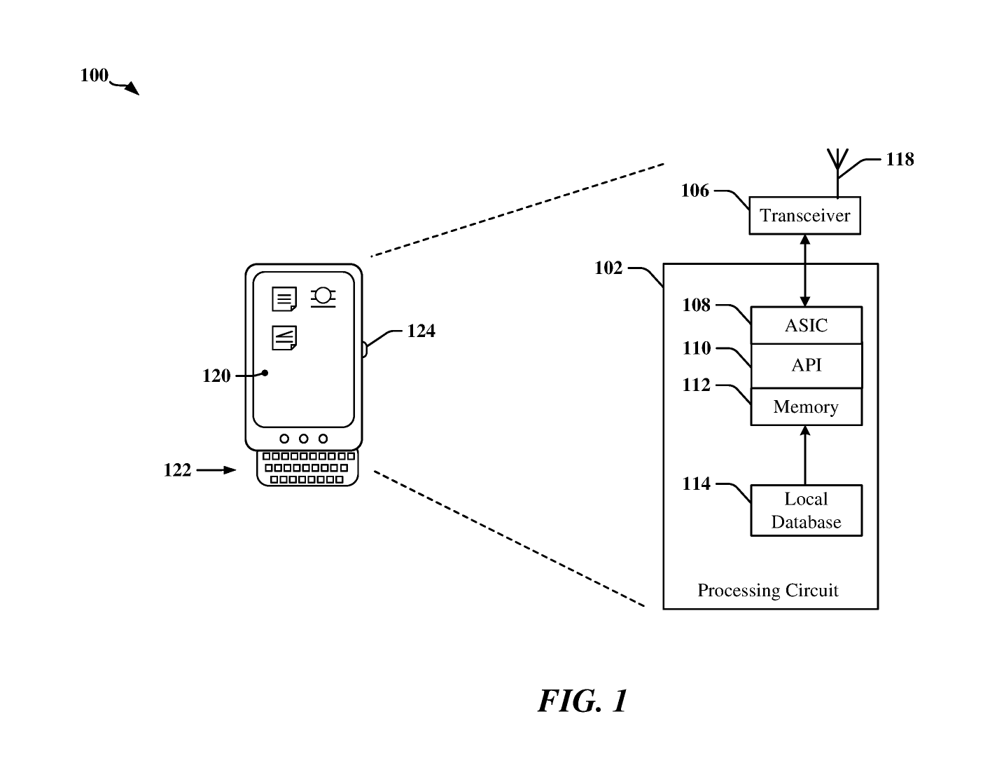

Certain aspects of the invention may be applicable to communications links deployed between electronic devices that include subcomponents of an apparatus such as a telephone, a mobile computing device, an appliance, automobile electronics, avionics systems, etc. FIG. 1 depicts an apparatus 100 that may employ a communication link between IC devices. In one example, the apparatus 100 may include a wireless communication device that communicates through an RF communications transceiver 106 with a radio access network, a core access network, the Internet and/or another network. The communications transceiver 106 may be operably coupled to a processing circuit 102. The processing circuit 102 may have one or more IC devices, such as an ASIC 108. The ASIC 108 may include one or more processing devices, logic circuits, and so on. The processing circuit 102 may include and/or be coupled to processor readable storage such as a memory device 112 that may maintain instructions and data that may be executed by a processor on the processing circuit 102. The processing circuit 102 may be controlled by one or more of an operating system and an application programming interface (API) 110 layer that supports and enables execution of software modules residing in storage media, such as the memory device 112 of the wireless device. The memory device 112 may include read-only memory (ROM) or random-access memory (RAM), electrically erasable programmable ROM (EEPROM), flash cards, or any memory device that can be used in processing systems and computing platforms. The processing circuit 102 may include or access a local database 114 that can maintain operational parameters and other information used to configure and operate apparatus 100. The local database 114 may be implemented using one or more of a database module, flash memory, magnetic media, EEPROM, optical media, tape, soft or hard disk, or the like. The processing circuit may also be operably coupled to external devices such as an antenna 118, a display 120, operator controls, such as a button 124 and/or an integrated or external keypad 122, among other components.

### Examples of Communications Links Provided Between IC Devices

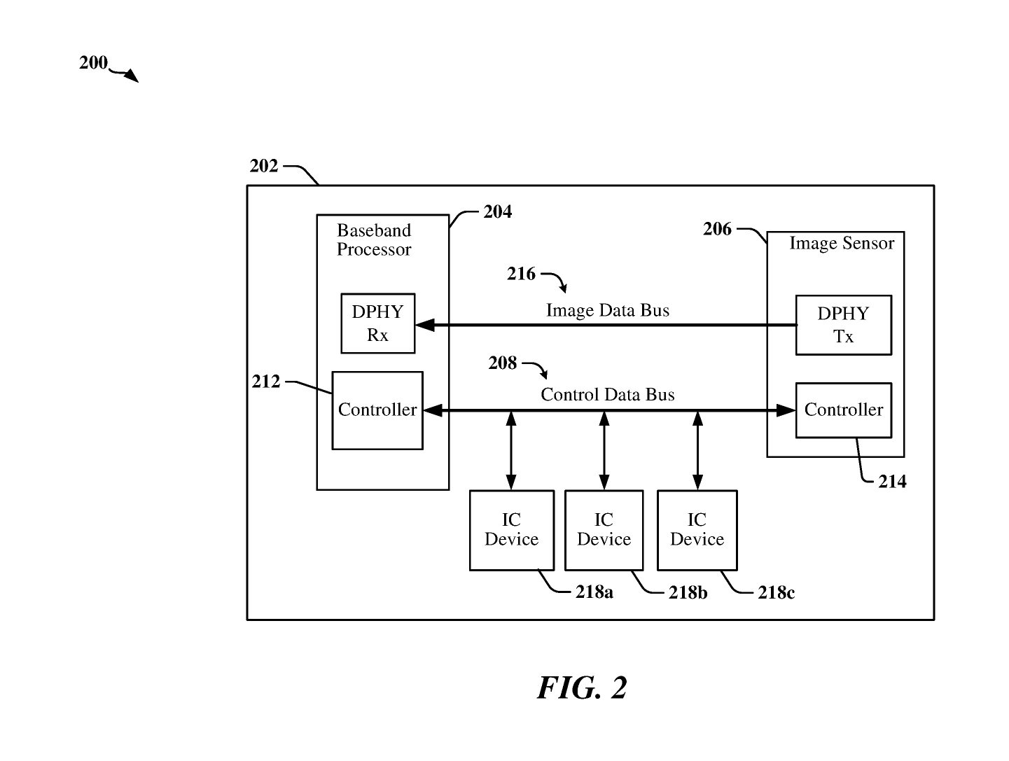

FIG. 2 is a block diagram 200 illustrating a simplified example of a device 202 that is constructed from multiple IC devices 204, 206, 218a, 218b, 218c. The illustrated device 202 may be a wireless communications device that includes various processors that handle RF signal processing, image capture and processing and other baseband (non-RF) control functions. The device 202 may be embodied in one or more of a wireless mobile device, a mobile telephone, a mobile computing system, a wireless telephone, a notebook computer, a tablet computing device, a media player, a gaming device, a wearable computing and/or communications device, an appliance, or the like. In one example, the device 202 may be implemented with a baseband processor 204 and an image sensor 206 and multiple communications buses 208, 216, including an image data bus 216 and a multi-mode control data bus 208. The block diagram 200 relates to a camera-equipped device 202 by way of example only, and various other devices and/or different functionalities may implement, operate and/or communicate using the control data bus 208 and/or a high-speed bus such as the image data bus 216.

In the depicted example, image data may be sent from the image sensor 206 to the baseband processor 204 over the image data bus 216, which may be implemented as a “DPHY” high-speed differential link defined by MIPI. In one example, the control data bus 208 may have two wires that are configurable for operation in an I2C bus mode. Accordingly, the control data bus 208 may include wires that carry data, and a clock signal used to synchronize data transfers over the control data bus 208. Data lines and the clock line may be provided to multiple devices 212, 214, 218a, 218b, and 218c coupled to the control data bus 208. In the example, control data may be exchanged between the baseband processor 204 and the image sensor 206 as well as other peripheral devices 218 via the control data bus 208.

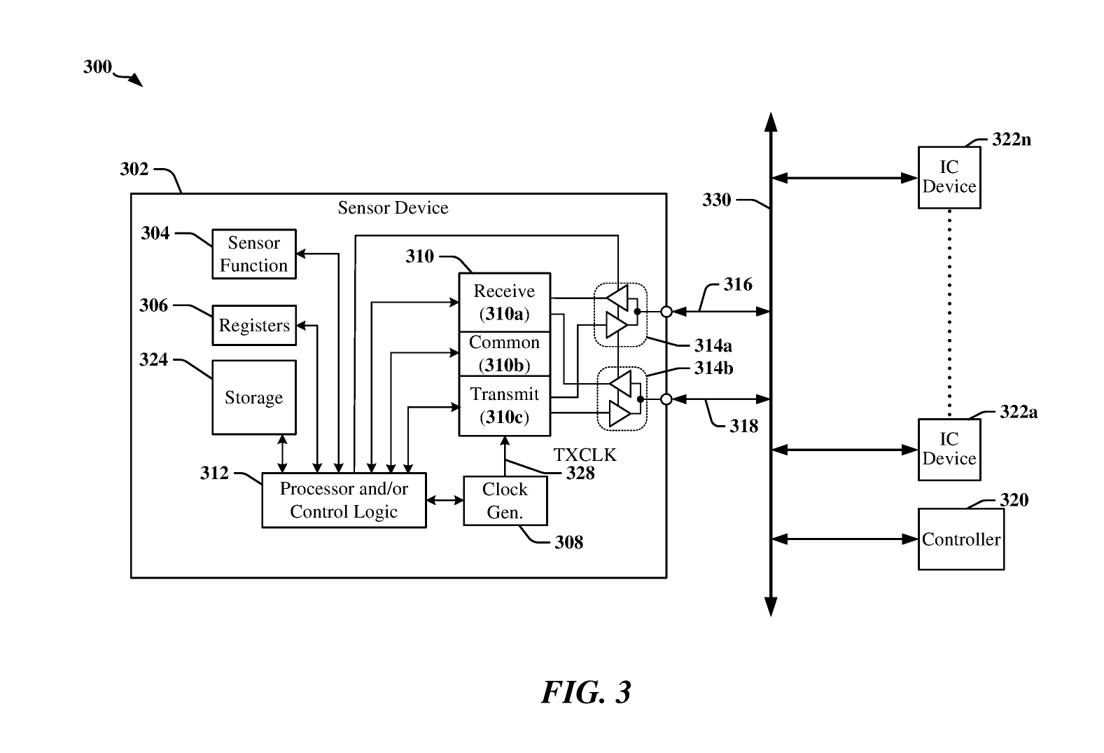

FIG. 3 is a block schematic diagram illustrating another example of an apparatus 300 that may employ the control and/or data bus 330 to connect multiple IC devices 302, 320, 322a-322n. The control and/or data bus 330 may be configured according to application needs, and access to multiple buses 330 may be provided to certain of the IC devices 302, 320, and/or 322a-322n. For example, a low data rate, low-power control and/or data bus 330 may be provided for communication between certain IC devices, and those IC devices 302, 320, and/or 322a-322n that have a need to transmit large quantities of data and/or time sensitive data may be coupled to a high data rate control and/or data bus 330.

In the example illustrated in FIG. 3, a sensor device 302 is coupled to a controller 320 through the control and/or data bus 330. In one example, the sensor device 302 may be provided in an IC device adapted to provide a sensor control function 304 that manages an image sensor, for example. In another example, the sensor device 302 may be adapted to provide a sensor control function 304 that monitors an environmental condition, or the operational state of a machine. The sensor device 302 may include configuration registers 306 and/or other storage devices 324, a processing circuit and/or control logic 312, a transceiver 310 and a number of line driver/receiver circuits 314a, 314b as needed to couple the sensor device 302 to a multi-wire control and/or data bus 330. The processing circuit and/or control logic 312 may include a processor such as a state machine, sequencer, signal processor or general-purpose processor. The transceiver 310 may include one or more receivers 310a, one or more transmitters 310c and certain common circuits 310b, including timing, logic and storage circuits and/or devices. In some instances, the transceiver 310 may include encoders and decoders, clock and data recovery circuits, and the like. A transmit clock (TXCLK) signal 328 may be provided to the transmitter 310c, where the TXCLK signal 328 can be used to determine data transmission rates.

The IC devices 302, 320, and/or 322a-322n may communicate using the control and/or data bus 330. The control and/or data bus 330 may support unidirectional, bidirectional half-duplex or full-duplex modes of communication. The IC devices 302, 320, and/or 322a-322n may transmit data to other IC devices 302, 320, and/or 322a-322n. In some instances, certain IC devices 320 may be configured as a bus master, and certain devices 302, and/or 322a-322n may be configured as slave devices. The IC devices 302, 320, and/or 322a-322n may be compatible with, or compliant with one or more communications standards, protocols and signaling specifications.

The control and/or data bus 330 is typically implemented as a serial bus in which data is converted from parallel to serial form (i.e. serialized) and/or encoded in sequences of symbols by a transmitter, which transmits the encoded data as a serial bitstream. A receiver processes the received serial bitstream using a decoder and/or serial-to-parallel convertor to decode and deserialize the data. In one example, the I2C bus provides two bidirectional lines 316, 318. Data may be serialized and transmitted on a Serial Data Line (SDA) 318 in accordance with a clock signal transmitted on a Serial Clock Line (SCL) 316. In some examples, data may be encoded and transmitted as symbols on two or more lines 316, 318. In some examples, data may be transmitted concurrently on independent channels using separate lines of a control and/or data bus 330.

### Serial Interface Configurations

A serial interface can be defined using an electrical specification and a protocol specification. The electrical specification may define certain parameters appropriate to a desired or predefined process technology. The design of an IC device can be a long, costly and risky process due to the complexity of a typical IC device, layout, analog and/or custom digital design and verification in silicon issues. Accordingly, it may be less desirable to modify or improve a communication interface for an IC device through changes in process technology to obtain desired electrical characteristics for a serial interface. Certain aspects disclosed herein take advantage of the many degrees of freedom associated with certain protocol specifications.

Modifications of a communication interface that abide by a pre-existing electrical specification and alter or enhance the protocol specification can be verified in digital simulation and emulation independent of process technology. Accordingly, the tradeoffs between cost, area, performance, power consumption, etc. can be evaluated at early stages of a design and development process.

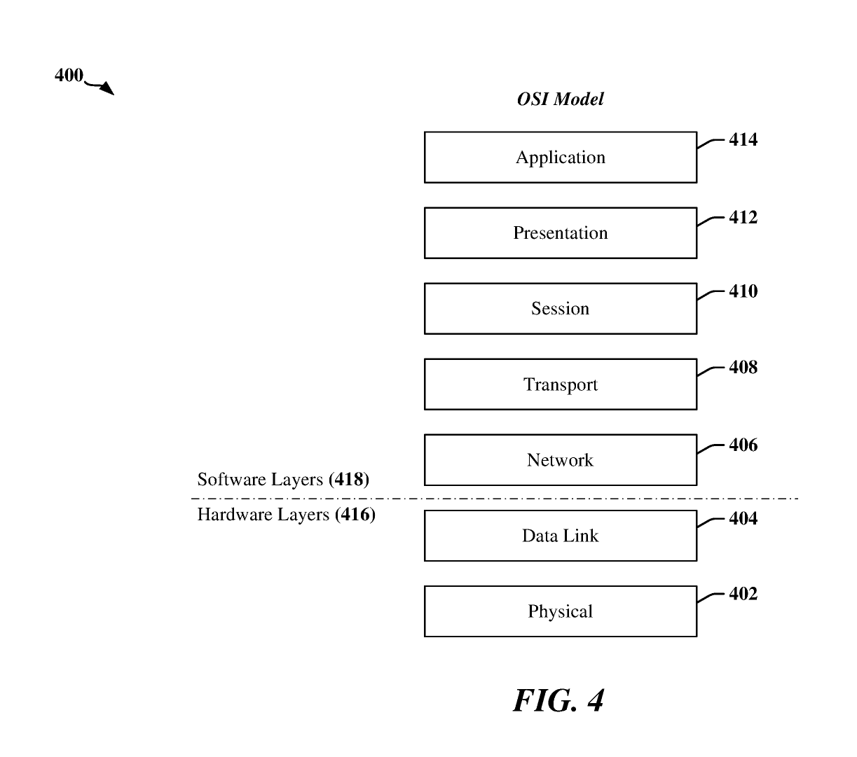

A network is usually represented in the OSI 7-layer model, which is illustrated in the protocol stack 400 depicted in FIG. 4. The Physical Layer 402 defines the logical, electrical and physical specifications for a communication interface and defines a protocol that permits two devices to terminate a connection between the two devices. Functional modules provided in the Physical Layer 402 may control transmission and reception of raw bit streams over a physical medium, such as the serial control and/or data bus 330. The Data Link layer, or Link Layer 404 is responsible for providing reliable communication of data frames between the two devices connected using the Physical Layer 402, and the Network Layer 406 structures and manages connections in a multi-device network. The Network Layer 406 may, for example, provide addressing and routing of data to be transmitted over the serial control and/or data bus 330.

The Transport Layer 408 provides for reliable transmission of data between devices on a network, including segmentation of data, acknowledgement and multiplexing functions. The Session Layer 410 establishes, maintains and terminates connections between devices. The Presentation Layer 412 provides various services for applications that are interfaced through the Application Layer 414. The services may include data translation, character encoding, data compression, data encryption, and/or data decryption. A combination of hardware and software may be provided to implement a desired network architecture. Typically, lower layers of the protocol stack 400 are implemented in hardware to a greater extent than upper layers of the protocol stack 400. For the purposes of this description, the Physical Layer 402 and the Link Layer 404 may be referred to as the “Hardware Layers 416,” although these layers may include some combination of hardware and software modules or components. Similarly, the layers other than the Physical Layer 402 and the Link Layer 404 may be referred to as the “Software Layers 418,” although these layers may include some combination of hardware and software modules or components.

While central functions of each layer are typically well-understood, the boundaries and interfaces between layers may not be strictly defined. Accordingly, certain aspects disclosed herein provide design optimizations by enhancing or modifying the inter-workings of certain layers of the protocol stack 400, while maintaining compatibility with the specifications associated with the Hardware Layers 416.

The Physical Layer 402 may be divided into an electrical sub-layer and a physical coding sub-layer (PCS). The PCS provides a foundation for a protocol specification, defining signal structure and formats as seen on the interface. In the example of a serial interface, the PCS may define a data stream as a sequence of digital values representing logical ones and zeroes.

The PCS may indicate the state of the data transfer. In the example of a general-purpose interfaces such as PCI-E, USB, and Ethernet, the PCS may identify two basic states, including an active data transfer state, and an idle state that may be used to convey control information and messages related to link status. Link status information may include power state, link training status, etc. In multi-media interfaces, three states may be defined including a primary data transfer state, where primary data may include video data for example, a secondary data transfer state, where secondary data may include audio data, and an idle state that may also be referred to as a blank state. With reference again to FIG. 2, primary and/or secondary data transfers may be effected using a primary data bus (e.g., the Image Data Bus 216) while a side-band channel (e.g., the Control Data Bus 208) may be used as a for communications related to link initialization and transitions between power states. For example, HDMI provides an I2C bus as a side-band channel, and DisplayPort defines an auxiliary channel as a side-band channel.

The PCS may be responsible for providing and/or ensuring DC-balanced code words, data boundary recognition and robustness against bit errors. A waveform may be described as DC-balanced when the waveform has substantially no DC component, such as when the mean value of the waveform amplitude has a zero value. The PCS may provide DC-balance in the data stream by preventing long-running sequences of constant zeroes or ones, which can result in electrical degradation of high-speed signals. Systems according to USB, PCI-E, and DisplayPort standards may employ the American National Standards Institute (ANSI) 8-bit/10-bit coding scheme to combat run-length issues that may lead to loss of DC-balance. An 8-bit/10-bit coding scheme may translate an 8-bit data word into a 10-bit code word, or character, such that a stream of 10-bit code words is statistically DC-balanced. The HDMI standard uses an 8-bit/10-bit coding scheme defined for transition-minimized differential signaling (TMDS), which may be used to transmit high-speed serial data.

Data boundary recognition provides patterns that can identify the boundaries of a code word. Data may be provided bit-by-bit for transmission without a sideband signal indicating the start or end of a code word, symbol or character, and a code used for transmission may provide boundary recognition through the use of patterns that can adequately identify the boundaries of a code word. The patterns may be referred to as synchronization symbols. Synchronization symbols are transmitted at the beginning of transmissions. A receiver may be said to have locked to the pattern when it has recognized the character boundaries and the link is ready for transfer of actual data. From time to time, synchronization symbols can be transmitted between data transfers to enable the receiver to check the validity of the pattern lock.

The PCS is expected to provide robustness against bit errors. Accordingly, synchronization symbols may be selected to be recognizable even in the presence of bit errors. The hamming distance between a code word representing a synchronization symbol and another code word representing regular data must typically be at least greater than one to avoid false synchronization. The hamming distance may be calculated as the number of bit positions at which two symbols differ. In a 10-bit code word, a space of 1024 code words is available for representing 8-bit data (256 values), and the sub-space used for data and the sub-space used for special code words to control or monitor link status can be allocated with sufficient hamming distance from each other. Also, each code word selected from a sub-space can be allocated with sufficient hamming distance from any other code word selected from the sub-space, if the size of the sub-space is larger than the minimum size needed for the number of used code words. In this way, a code can be designed with built-in support for error detection and possible error correction.

Due to the popularity of 8-bit/10-bit coding schemes, most of the circuitry supporting the electrical sub-layer of the Physical Layer 402 converts between a serial bit stream at the nominal bit rate and a parallel 10-bit wide data stream at one tenth of the nominal bit rate. A circuit supporting this conversion is called SerDes (i.e. Serializer/De-Serializer).

The widely used 8-bit/10-bit codes have the drawback of 25% coding overhead. For every 8 bits of data, 2 additional bits are transmitted. Therefore, different schemes are used in certain interfaces to obtain a higher bitrate and to utilize the available bandwidth more efficiently. One such scheme is the 64-bit/66-bit coding scheme used in 10G-base Ethernet. In this scheme, a 2-bit synchronization symbol is inserted for every 64 bits (or 8 bytes) of data. The overhead of this scheme is 3.125%. The 128-bit/130-bit coding scheme used in PCI-E for bit rates above 5 Gbps provides even further coding efficiency, by inserting a 2-bit synchronization symbol for every 128 bits (or 16 bytes) of data. The overhead here is reduced to 1.5625%.

The period between a pair of neighboring synchronization symbols is called a PCS frame. The 2-bit synchronization symbol can be used to indicate link status, i.e., data transfer or idle status. Any detail about the link status can be indicated by bits transmitted (e.g. 64 bits or 128 bits) within the PCS frame.

### Techniques for Addressing Deficiencies in PCS Encoding Schemes

Conventional encoding schemes employed by the PCS provide poor support for DC-balance, character boundary recognition and robustness against bit errors. A 2-bit synchronization symbol that is composed of a zero and a one can only guarantee that the longest sequence of consecutive zeroes or ones in the 64-bit/66-bit scheme and the 128-bit/130-bit scheme cannot exceed 65 and 129, respectively. To address this issue, a scrambler is commonly used to transform the data stream into a sequence of more evenly distributed zeroes and ones. However, this distribution is statistical in nature, and there is no guarantee against the occasional sequence of long-running zeroes or ones. The Interlaken protocol uses a 64-bit/67-bit scheme instead of a 64-bit/66-bit scheme by inserting an extra bit to improve DC-balance, deciding between a ‘0’ and a ‘1’ dynamically on a case-by-case basis.

In some instances, the Link Layer 404 may be adapted to address concerns regarding character boundary recognition and error handling in the context of the 64-bit/66-bit scheme or any scheme where the PCS inserts synchronization symbols between data words while leaving the data words unaltered. The Link Layer 404 cannot use the full bandwidth for raw data transmission, and support may be provided for sending special data patterns to enable the receiver to recognize character boundaries and align the data stream to those character boundaries. Support may be provided to generate a checksum for monitoring the quality of data transfer. The checksum may be implemented as a cyclic redundancy check (CRC).

If a CRC performed by the receiver reports an error, the data must typically be discarded or re-transmitted. Re-transmission is possible when a bi-directional transceiver is used, and when an automatic retransmission request (ARQ) can be sent from the data receiver to the data transmitter. If re-transmission is not feasible and discarding data is not acceptable, an error correction code (ECC) can be sent along with the data. Any such provisions use additional bandwidth. Therefore, even if the PCS overhead of a 128-bit/130-bit scheme is only 1.5625%, the overhead due to the link-layer protocol (CRC, ECC, ARQ) must be accounted for as well. However, the additional overhead should still be less than the 25% associated with the 8-bit/10-bit coding scheme.

The Link Layer 404 may form data packets in a way that indicates the nature of the data itself. General-purpose interfaces such as PCI-E, Ethernet or USB use a header to provide metadata associated with the data. Such metadata can include, for example: the size of the data block that follows, a destination memory address for the data, the type of data transfer (e.g. read, write), and/or protocol features associated with the data block (e.g. acknowledge required, resend in case of error). Special-purpose interfaces such as multi-media interfaces can use a timed sequence for primary data that closely follows a standard video format timing specification and fixed time slots for secondary data.

Usually, data packets are sent in sequential order, one packet at a time. A protocol can also support a hierarchy of data packets. For instance, the PCI-E protocol may distinguish between transport layer packets where the payload comes from a higher layer and link layer packets where the payload is generated by the Link Layer 404 itself. Such link layer packets may enable certain aspects of link maintenance. Link layer packets may be required due to the complexity of the PCI-E protocol, and accordingly the link layer packets may represent an additional overhead. In some implementations, nested packets may be used, whereby a high priority data packet can be inserted in the middle of lower priority packet that is “in-flight,” effectively delaying the completion of transmission of the lower priority packet. The transmission of a nested packet increases overhead, and involves the use of special data symbols to indicate the start and end of the nested packet so it is not mistaken as a part of the packet in-flight and the transmission of the packet in-flight can properly resume after the nested packet.

In summary, the features in the PCS layers and link layer are dependent on each other. There is also a dependency between the features of the electrical layer and the PCS layer. Since the 8-bit/10-bit coding scheme is prevalent in many serial interfaces for rates below 5 Gbps, most SerDes designs, especially protocol-independent designs, convert between a serial bit stream and a 10-bit parallel stream (or multiples of 10-bit), even if the PCS frame is not a multiple of 10-bit, as it is the case in the 64-bit/66-bit and 64-bit/67-bit schemes. For such schemes, the PCS must typically have a so-called gearbox function that converts the data streams, using a state machine that rotates between different phases. The least common multiple between 10 and 66 being 330, this state machine goes through 33 phases in the 10-bit domain and 5 phases in the 66-bit domain.

### Overview of the Use of Enhanced Synchronization Symbols

Certain aspects of the present disclosure relate to the use of synchronization symbols and a scheme for their use that can yield lower overhead than conventional systems, while providing improved capabilities for link status indication, DC balance (using a scrambler) and error handling. In one example, improved link status indication may be obtained through the use of a robustly encoded pattern. In another example, DC balance may be improved through the use of a scrambler. In another example, error handling may be improved through the implementation of CRC and/or ECC schemes.

Synchronization symbols may be formed as 4-bit symbols. A 4-bit synchronization symbol can offer certain advantages over conventional 2-bit synchronization values.

A 4-bit synchronization symbol can provide improved DC balance when for example, 2 of the 4 bits in the symbol are set to zero (‘0’) with the remaining 2 bits being set to one (‘1’). Accordingly, the 4-bit synchronization symbol can be intrinsically DC-balanced, and also can terminate any running sequences of constant zeroes or ones in the immediately preceding transmission.

A 4-bit synchronization symbol can permit more robust link status check. A set of 4-bit synchronization symbols may be defined for a transmission scheme such that no legal symbol can be obtained by performing a left-shift operation or a right-shift operation on another legal symbol. Accordingly, any drift in transmission resulting in a bit shift can be reliably detected using the 4-bit synchronization symbol.

A 4-bit synchronization symbol can provide improved error checking. In one example, the set of 4-bit synchronization symbols may be chosen to obtain a minimum hamming distance between any two legal symbols of 3. This hamming distance enables error correction for 1-bit errors in each synchronization symbol. In another example, the set of 4-bit synchronization symbols may be chosen to obtain a minimum hamming distance between any two legal symbols of 2. This hamming distance enables detection of 1-bit errors in synchronization symbols, and error-correction can be accomplished using another criterion supported by the protocol.

The 4-bit synchronization symbol can support robust indication of 4 legal states, as opposed to two legal states available for a 2-bit synchronization symbol. Accordingly, additional signaling capability is provided through the use of 4-bit synchronization symbols. For example, packet boundaries and nested packets can be indicated by the synchronization symbol alone. The available bandwidth in each state can be fully utilized for transmitting data without overhead of special data symbols.

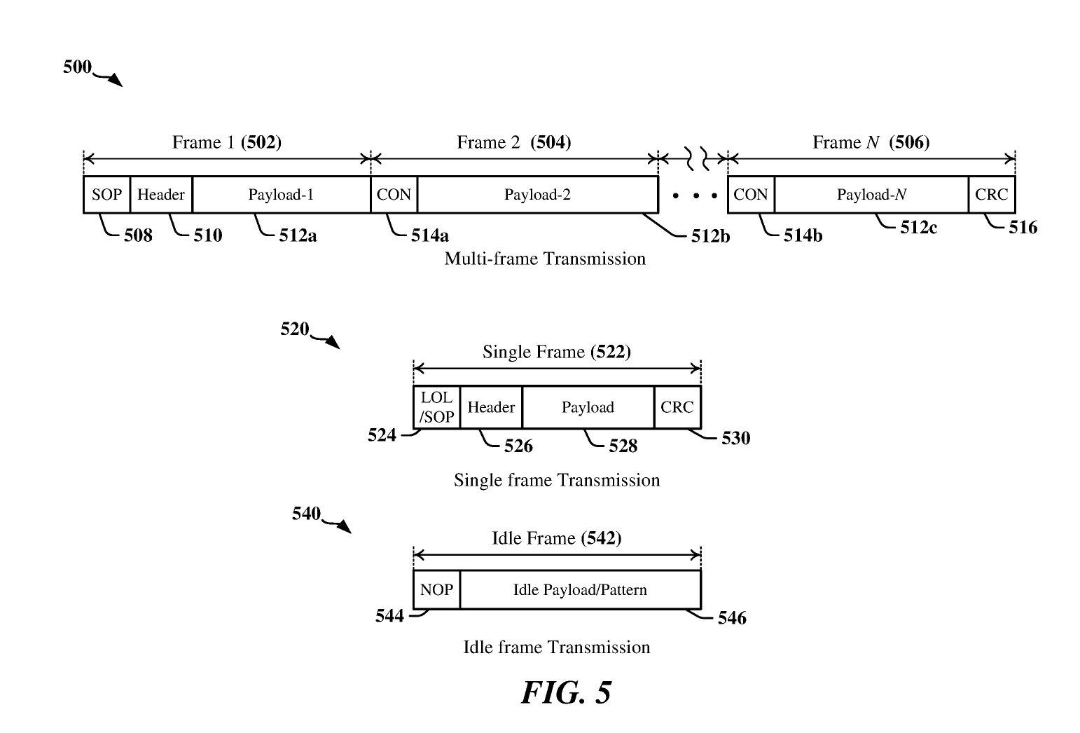

FIG. 5 illustrates the use of a set of multi-bit synchronization symbols to provide multiple transmission modes 500, 520, 540 on a serial communication link between IC devices. The set of multi-bit synchronization symbols may include symbols that have S bits, where S is greater than or equal to 4.

In a first transmission mode 500, a packet of data provided to the PCS may be of sufficient size that the PCS determines that the packet should be segmented for transmission in a number (N) of frames 502, 504, 506. The first frame 502 for transmission may include a part of the packet preceded by a start of packet (SOP) synchronization symbol 508. The part of the packet carried in the first frame 502 may include the packet header 510 and a first portion 512a of the data (Payload-1) provided in the packet. One or more succeeding frames 504, 506 may be transmitted as needed to convey the remainder of the data in the packet, and the packet CRC information 516 and/or error correction information if present in the packet. In the example, the second frame 504 includes data (Payload-2) 512a preceded by a continuation (CON) synchronization symbol 514a, and additional frames 506 may be transmitted as necessary. The final frame 506 may include a final portion of the data as Payload-N 512c with padding added as needed. The final frame 506 is preceded by a CON synchronization symbol 514b, with the CRC information 516 transmitted after the Payload-N 512c.

In a second transmission mode 520, a packet of data provided to the PCS may be small enough to fit within a single frame 522. The PCS may construct the frame 522 such that it includes a synchronization symbol 524, the header 526 of the packet, the data and/or padding (Payload) 528 of the packet, followed by the CRC information 530. The single frame 522 may carry a normal packet that may have been queued for transmission in normal order, in which case the synchronization symbol 524 may be the SOP synchronization symbol to indicate the start of a new packet. In some instances, the single frame 522 may be used to carry a high-priority or low-latency packet, in which case the synchronization symbol 524 may be a low-latency synchronization symbol (LOL). A packet may be designated as a low-latency packet when it is associated with quality-of-service information indicating delay-sensitive data, such as audio or video streaming traffic.

In a third transmission mode 540, the PCS may transmit one or more idle frames 542. The idle frames may be transmitted when no data remains within the PCS for transmission. The idle frame includes an idle or no packet (NOP) synchronization symbol 544 and an idle payload 546 that can include a data pattern, padding, or other information. In some instances, the idle payload 546 produces a sequence of bits that is calculated or selected to prevent prolonged running sequences of constant zeroes or ones.

### Example Structures for Synchronization Symbols

The synchronization symbols may be constructed as S-bit values selected according to a predefined or preconfigured scheme. One scheme defines a PCS frame and synchronization symbols that satisfy the following conditions:

D modulo 8=0 (i)

(D+S)modulo 10=0 (ii)

where D is the number of data bits in a PCS frame, and S is the number of synchronization bits in the same PCS frame. In one example, S=4. The total number of bits in a PCS frame is D+S. This number is equivalent to the time it takes for serial transmission of a PCS frame, measured in unit intervals (UIs), where one UI is the time for transmission of a single bit.

Condition (i) may result a PCS frame that includes an integral multiple of 8 bits (i.e. an integral number of bytes. The use of 8-bit bytes is well suited for use in many systems and applications, where data are usually represented, formatted, transmitted and stored in multiples of bytes.

Condition (ii) may result in a PCS frame being captured, transmitted and received in an integral number of clock cycles at the rate used for a 10-bit parallel data stream. Accordingly, a gearbox may not be needed.

The coding overhead for a D-bit/(D+S)-bit scheme may be expressed as:

$$\frac{D}{D + S} \times 100 \% .$$

In the example where S=4, solutions satisfying Condition (i) and Condition (ii) yield various schemes such as 16-bit/20-bit (25% overhead, 2 clocks per frame), 56-bit/60-bit (7.1% overhead, 6 clocks per frame), 96-bit/100-bit (4.2% overhead, 10 clocks per frame), 136-bit/140-bit (2.9% overhead, 14 clocks per frame) and so on. Table 1, below illustrates state indication by a 4-bit synchronization symbol, where the mnemonics NOP, SOP, CON, and LOL are used to identify the symbol.

TABLE 1

| State of PCS frame | Symbol | Bit code (example) |
|---|---|---|
| Idle pattern: No Packet | NOP | 0100_{base2} |
| Regular packet: Start of Packet | SOP | 1010_{base2} |
| Regular packet: Packet Continues | CON | 0011_{base2} |
| Low-Latency nested packet | LOL | 1101_{base2} |

The bit code entries in Table 1 illustrate the implementation of one example for a scheme where the hamming distance between a symbol indicating a regular packet (SOP or CON) and a symbol indicating a state other than regular packet (NOP or LOL) is 3. In this scheme, the entry and exit of the regular packet state can be reliably detected and corrected in presence of a 1-bit error. Table 2 shows the Hamming distance between PCS frame synchronization symbols.

TABLE 2

| | NOP | SOP | CON | LOL |
|---|---|---|---|---|
| | (0100_{base2}) | (1010_{base2}) | (0011_{base2}) | (1101_{base2}) |
| NOP (0100_{base2}) | 0 | 3 | 3 | 2 |
| SOP (1010_{base2}) | 3 | 0 | 2 | 3 |
| CON (0011_{base2}) | 3 | 2 | 0 | 3 |
| LOL (1101_{base2}) | 2 | 3 | 3 | 0 |

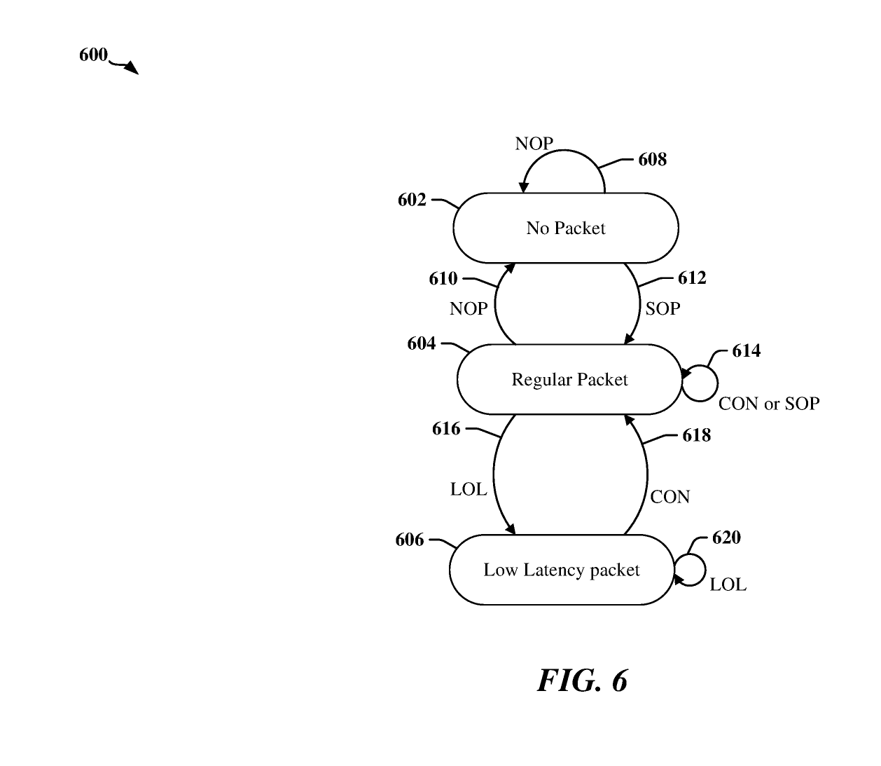

PCS transmissions may be controlled by a processing circuit, which may include one or more state machines. In one example, the PCS transmissions may be controlled in accordance with the state diagram 600 depicted in FIG. 6. Table 3 shows entry and exit conditions for the PCS states illustrated in FIG. 5. Entry and exit conditions are indicated by the synchronization symbol. The PCS transmission states in the illustrated state diagram 600 include an idle or No Packet state 602, a Regular Packet state 604, and a Low Latency Packet state 606. The low latency packet is typically transmitted in a single frame. In some instances, a packet that would qualify as a low latency packet may be treated as a regular packet when the PCS is in the No Packet state 602.

TABLE 3

| Current | Current | | Next | |
|---|---|---|---|---|
| state | symbol | Next state | symbol | Comment |
| No Packet | NOP | No Packet | NOP | Link remains idle |
| | | Regular Packet (start) | SOP | Packet starts after idle |
| Regular | SOP | No Packet | NOP | Packet finished, return to idle |
| Packet | | Regular Packet (start) | SOP | Packet starts |
| (start) | | | | (back-to-back regular packet) |
| | | Regular packet (continue) | CON | Packet continues |
| | | Low Latency Packet | LOL | Low-latency packet inserted |
| | | | | (regular packet on hold) |
| Regular | CON | No Packet | NOP | Packet finished, return to idle |
| Packet | | Regular Packet (start) | SOP | Packet starts |
| (continue) | | | | (back-to-back regular packet) |
| | | Regular packet (continue) | CON | Packet continues |
| | | Low Latency Packet | LOL | Low-latency packet inserted |
| | | | | (regular packet on hold |
| Low | LOL | Regular Packet (continue) | CON | Regular packet continues) |
| Latency | | Low Latency Packet | LOL | Back-to-back low-latency packet |
| Packet | | | | |

The PCS may transition 612 from the No Packet state 602 to the Regular Packet state 604 or may remain 608 in the No Packet state 602. A transition 612 to the Regular Packet state 604 may occur when a data packet is available for transmission, and the start of the data packet and corresponding transition 612 may be indicated using an SOP symbol. When the PCS determines that no data packet is available for transmission, then the PCS remains in idle mode. The PCS may indicate the self transition 608 as a NOP and an idle frame preceded by a NOP symbol may be transmitted. In one example, the Hamming distance between the NOP and SOP symbols is 3. Therefore, entry into Regular Packet state 602 from No Packet state 602 can be reliably detected.

The PCS may transition 616 from the Regular Packet state 602 to the Low Latency Packet state 606, may transition 610 to the No Packet state 602, or may remain 614 in the Regular Packet state 604. The PCS may remain in the Regular Packet state 604 while a portion of a current packet remains for transmission in one or more continuation frames. Continuation frames are indicated by a CON symbol. The PCS may transition to the Low Latency Packet state 606 when a portion of a current packet remains for transmission and a low latency packet has been received for transmission. Transmission of the current packet may be suspended and the latency packet may be transmitted with the LOL symbol indicating the transition 616 to the Low Latency Packet state 606. The PCS may transition 610 to the No Packet state 602 when transmission of a current packet has been completed and no further packets are available for transmission. An idle frame may be transmitted with a NOP symbol indicating the transition 610 to the No Packet state 602. The Hamming distance between the either of the SOP or CON symbols and either of the NOP or LOL symbols is 3. Therefore, transitions 610, 616 from the Regular Packet state 604 can be reliably detected.

The Hamming distance between the sub-states within “Regular Packet” (i.e. SOP and CON) and outside “Regular Packet” (i.e. NOP and LOL) is 2. The specification of the link layer can be used to safely distinguish between those sub-states in case of 1-bit error.

The PCS may transition 618 from the Low Latency Packet state 606 to the Regular Packet state 604 or may remain 620 in the Low Latency Packet state 606. The transition 618 to the Regular Packet state 604 may occur after a low latency packet has been transmitted and no further low latency packets are available for transmission by the PCS. The return to the Regular Packet State 604 may be indicated by transmission of a CON synchronization symbol, indicating resumption of transmission of a packet that was in progress before transition 616 to the Low Latency Packet state 606. When an additional low latency packet is available for transmission while the PCS is in the Low Latency state 606, an LOL symbol may be transmitted in the next frame. The Hamming distance between the LOL and CON symbols is 3. Therefore, the re-entry into Regular Packet state from Low Latency Packet state can be reliably detected.

### Link Layer Considerations

The Link Layer 404 specifies packet formats. According to certain aspects disclosed herein, the overhead associated with generation and processing of metadata may be minimized and a reliable method for distinguishing between link layer states is provided. Link layer states may include the sub-states internal and external to the Regular Packet state 604.

Techniques are disclosed herein that can be applied when a packet transmission starts at a PCS frame boundary and terminates at a PCS frame boundary. The start of a packet is indicated by a header, typically with a fixed size. The Link Layer 404 can distinguish between frames that are to be transmitted with an SOP symbol and frames that are to be transmitted with a CON symbol based on the presence or absence of a header at the start of a frame. The Link Layer 404 can also distinguish between frames that are to be transmitted with an LOL symbol and frames that are to be transmitted with an NOP symbol based on the presence or absence of a header at the start of a frame, or between LOL and NOP by the presence or absence of a header at the start of a frame. A CRC or ECC with fixed size and fixed position at the end of the packet may be used to check the integrity of the payload of a packet. When a long packet is to be transmitted, CRCs may be transmitted at multiple fixed positions within the packet. For example, a CRC may be provided periodically after each 128 bytes.

The header and CRC may be considered to be link-layer overhead. For example, the header and CRC can be 2 bytes each, resulting to a 4-byte overhead. The longer the packet (i.e. the larger the payload), the lower the relative overhead. For example, if the payload is 16 bytes, the overhead is 25%. However, if the payload is 128 bytes, the overhead is only 3.125%.

An ECC may be provided for low latency, high-priority and/or high importance packets including, for example, packets considered to be mission-critical. Accordingly, the ECC may be limited to packets short enough to fit within one PCS frame to enable such packets to be sent with low latency. The ECC may be provided when mission-critical data requires immediate error detection and correction. An ECC can fit into 1 byte instead of the 2 bytes used for CRC, and the link-layer overhead may be reduced from 4 bytes to 3 bytes.

For longer packets, CRC may be preferred over ECC. A CRC word can be effective in detecting more bit-errors than an ECC word of the same length can correct. The probability of multiple bit-errors increases with packet size. In some instances, the size of the CRC can be increased with packet size based on a tradeoff between overhead and error detection. The maximum packet size can be determined by the tolerable latency for data transfer, since the integrity of the payload is typically decided after CRC calculation at the end of the packet.

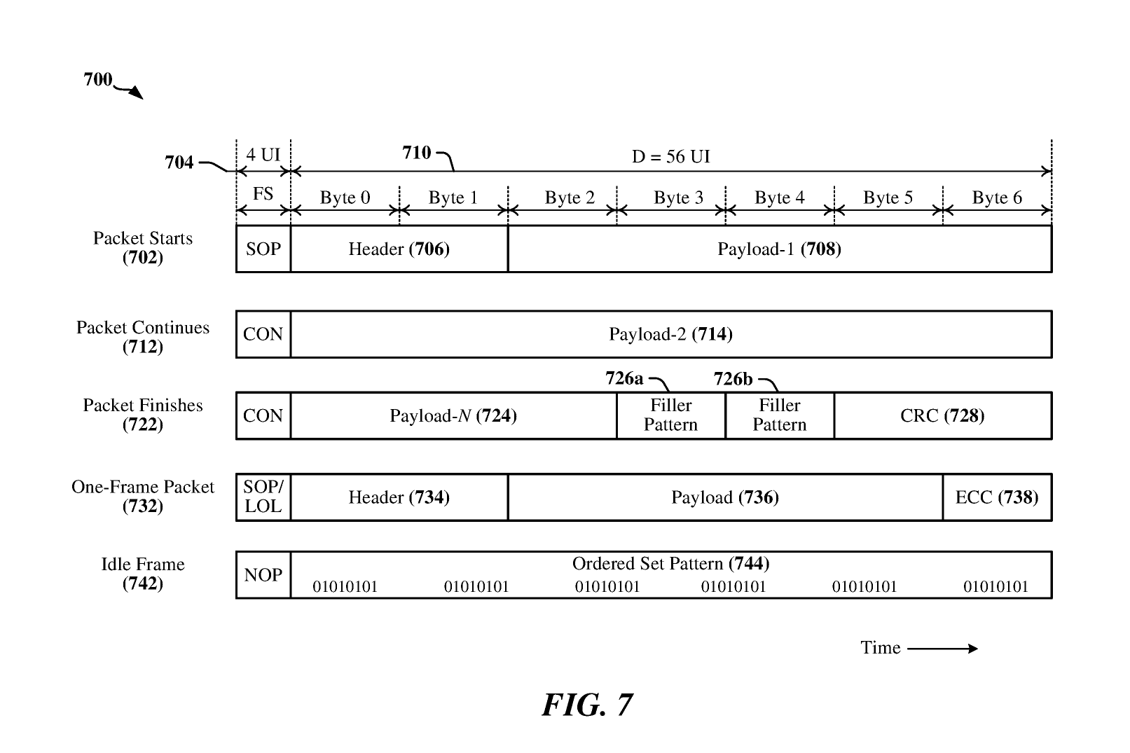

FIG. 7 is a packet timing diagram 700 for one example of a PCS frame structure. In the example, the PCS frame employs synchronization symbols having a size S=4 bits transmitted in a 4 UI interval 704, and the PCS frame carries 7 bytes of data transmitted in a 56 UI period 710. The size of the packet header 706, 734 may be 2 bytes. The size of an ECC 738 provided in a short packet is 1 byte. The latter short packet may fit into a single PCS frame 732 having a 2-byte header 734, a 4-byte payload 736, and a 1 byte ECC 738.

A packet that is to be transmitted in two or more PCS frames, 702, 712, and/or 732 may be provided with a CRC 728 with a length of 2 bytes. The header 706 may be transmitted in a starting packet frame 702 and the payload 708, 714, 724 may be transmitted in one or more continuation frames 712, 722, as needed. The CRC 728 is transmitted in the final frame (i.e., the Nth frame) 722. If the payload 724 does not completely fill a frame, padding 726a, 726b may be provided between the end of the payload 724 and the CRC 728. The padding 726a, 726b may include one or more sequences of bits arranged according to a desired pattern. In one example, the padding 726a, 726b may be provided as all-zero filler bytes such that the CRC calculator does not need to know the exact size of the payload 708, 714, 724, because trailing zeroes do not affect the result of the CRC calculation. Filler bytes may be considered to be link-layer overhead and, in some instances, a packet size may be selected to minimize the need for filler bytes.

In some examples, the Link Layer 404 processes ECC and performs running CRC calculations for each frame. Accordingly, the start and end of a packet can be detected even when a bit error occurs in the frame synchronization symbol or in the body of the frame.

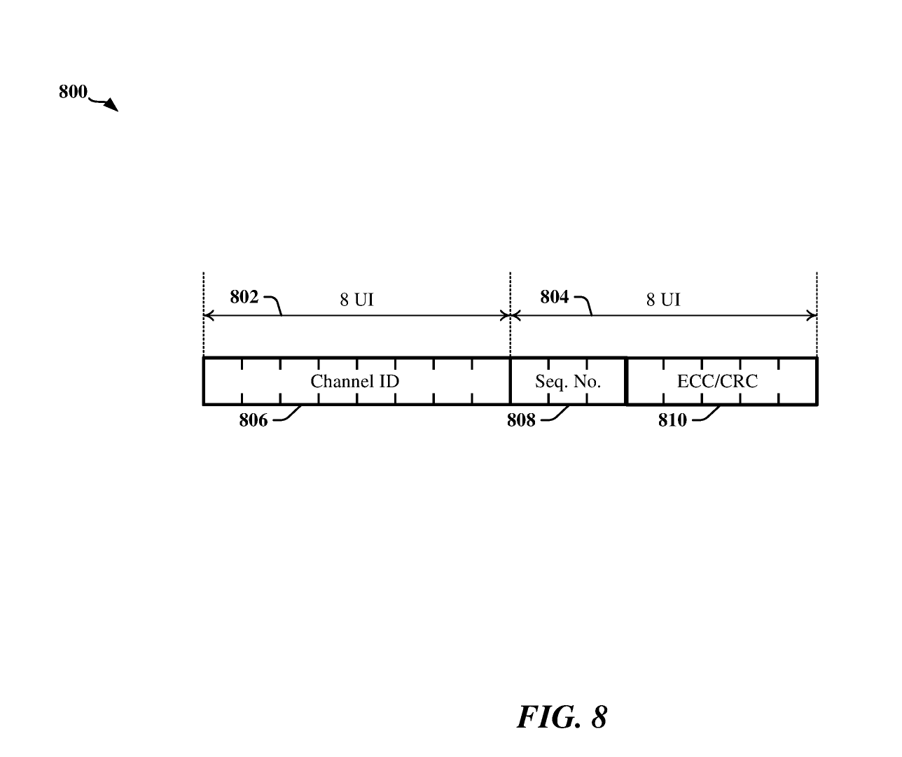

FIG. 8 illustrates the format of a 2-byte header 800 in a data packet. The format and contents of the header 800 can provide additional information that may act as a reliable guard-band against multiple bit errors. The header 706, 734 includes an 8-bit channel identifier (Channel ID) 806 occupying the first 8 UI intervals 802. The second 8 UI intervals 804 carry a 3-bit sequence number 808 and a 5-bit ECC or CRC field 810. The ECC/CRC field 810 may be used to carry a single-bit error correction, dual-bit error detection (SECDED) code. That is, the SECDED code can detect and correct a single-bit error and detect, but not correct, a dual-bit error.

The channel ID 806 may be used to indicate the routing information of the packet. In one example, the routing information includes source and destination information. All metadata associated with a packet may be associated with the channel ID. The metadata may include payload size, target address in a destination memory, requirement for response, requirement for re-transmission in case of failure, and other information. A set of metadata may be pre-defined for each channel ID. For example, channel ID 0x0 may be used for packets of size 128 byte routed from point A to point B, channel ID 0x1 may be used for packets containing messages of size 4 byte and requiring re-transmission in case of failure, and so on.

The sequence number 808 may be used to detect whether a packet has been dropped or missed on a channel. In one example, the sequence number has a value that is initially 0 and incremented by 1 for each packet transmitted. The sequence number 808 may rollover to 0 (restart) when the sequence number 808 value reaches the maximum count. In the example of a 3-bit sequence number 808, the maximum value for the sequence number 808 is 7. In some instances, it is expected that no more than one packet can go missing, and a one-bit error-correction code can be included in the 3-bit sequence number 808. For example, the one-bit error-correction code may alternate between 0 and 1 such that a bit error in the sequence number itself can be reliably detected and corrected.

The ECC/CRC field 810 may carry a SECDED code that provides protection against errors in the channel ID 806. Error detection for the header 800 reduces the likelihood of a packet being transmitted to or received at an incorrect destination, where it would be incorrectly processed. The immediate detection of an error in the packet header can also enable a faster retransmission, as needed. Without SECDED, an error in the header may be detected after CRC calculation, at which time it may be too late for retransmission.

Other efficiencies can be obtained through the use of error correction in the header 800. Certain packets may be able to tolerate some errors and can be processed at their destination even in the presence of bit errors. Provided the header 800 identifies the destination correctly, such packets can be immediately forwarded to their destination. There is typically no need to store such packets in an intermediate buffer until the CRC is calculated. In general, it is less harmful to send a packet with errors to the correct destination than to send a packet with or without error to the wrong destination.

### Idle Frame Signaling

A PCS coding scheme can be adapted to indicate low-level operations that are transparent to higher-level data transfers when the communication link is not transmitting packets. The link may be in a No Packet state 602 (see FIG. 6), as indicated by the NOP symbol at the beginning of a PCS frame, when packets are not being transmitted. The PCS frame transmitted during No Packet state 602 may carry a payload 744 (see FIG. 7) containing patterns of bits that indicate the low-level operations.

In one example, the bits can be grouped into units of 4 bits each, since the number of bits per frame satisfies Condition (i) (D modulo 8=0). For example, when D=56, there are 56/4=14 such units available in the payload 744 of the idle frame 742. Each 4-bit unit may take one of two predefined legal values to encode a single bit of information. In one example, a ‘1’ may be encoded as 1010_{base2}, while a 0 may be encoded as 0101_{base2}.

In this example, the encoding structure provides two legal codes with a hamming distance of 4. Therefore 1 error can be safely detected and corrected, and 2 errors can be safely detected. The two legal codes are DC-balanced, and the two legal codes have maximum transition density. Each idle frame 742 may provide a payload 744 with a number of possible states calculated as 2^{D/4}. In the example where D=56, the number of states that can be represented is 16384.

A PCS may define various states that can be indicated by the payload 744 of the idle frame 742. Uses of the states may include a default idle pattern, an alignment pattern, a scrambler operation, and an indication of transition into low-power state, among others. The states used or indicated may be defined based on application and features of the link controller.

Another useful property of this code is that it can be unambiguously distinguished from the packet format. For example, a 16-bit header of a regular packet includes an ECC. It is not possible to construct a 16-bit sequence consisting of 4 symbols, each symbol being either 0101_{base2} or 1010_{base2}, that forms a header with ECC.

### Multi-Lane Operation

Certain links may support a number (M) of lanes, where M>1, and where a link may be operated such that M PCS frames may be transmitted in a single PCS frame period. Various approaches to transmitting data over the multiple lanes are contemplated. An index (x), which can have a value 0≦x<M, is used to identity the M lanes as LANEₓ. In a first example, a set of PCS frames {N, N+1, N+2, . . . } may be assigned to the M lanes such that PCS frame N is assigned to LANE₀, PCS frame N+1 is assigned to LANE₁ and so on until a PCS frame is assigned to each lane. In the next PCS frame interval, the PCS frame N+M can be assigned to LANE₀, PCS frame N+M+1 is assigned to LANE₁, etc. In other words, PCS frame X may be assigned to lane Y if (X modulo M)=Y.

In a second example, data can be distributed across the M lanes at a byte level. Accordingly, adjacent bytes in a sequence of bytes for transmission can be assigned to adjacent lanes. The sequence of bytes can be identified with the index N, N+1, N+2 etc. In this way, byte X may be transmitted on lane Y if (X modulo M)=Y.

Assignment of data can be handled using any desired or preferred unit of data, where an integral number of such unit fits into a PCS frame. In the first example, the unit is the entire frame, in the second example, the unit is one byte. In another example, a unit of 4 bits, 2 bits or even 1 bit can be used. In any such example, the data mapping into M PCS frames is well defined. In particular, the position of a header (i.e. the start of a regular packet) within a PCS frame is well defined.

In a multi-lane mapping scheme, the header may not always immediately follow a synchronization symbol. In some instances, the header may be provided on LANE₀ in all transmissions. Synchronization symbols may be mapped by frame, independent of the data mapping scheme, which can operate by frame, by byte, and so on. For example, the synchronization symbol of PCS frame X may be assigned to lane Y if (X modulo M)=Y.

### Additional Descriptions of Certain Aspects

Certain aspects relate to the definition of packet formats. In one example, a packet format may include a header of fixed size, where the header has an ID, ECC and a sequence number. The ID may be a channel ID used to associate the packet with any metadata pertinent to the packet, such as packet size, destination address, size and format of payload CRC and/or ECC, expected response behavior in case of error-free transfer and in case of erroneous transfer. The sequence number may be used to identify a missing packet. The ECC may be used to protect the ID and/or the sequence number against bit errors. Any metadata can be preconfigured per ID and thus need not be transmitted every time a packet with the corresponding ID is transmitted. This can reduce redundancy and can improve fail-safe behavior, because if metadata is transferred repeatedly whether changed or not, a receiver cannot decide a priori whether a change of received metadata is intentional or the consequence of an erroneous transfer.

Packet data may be placed in a PCS frame that has a fixed-size, fixed-position packet header. In this way, the presence of a packet header can be determined by examining the data at a predefined position. In conventional schemes, such as PCI-E, a packet header can appear at any position within a frame, and the PCI-E packet header can be of variable length. Due to the variable size and position, conventional schemes require additional framing tokens in the body of the packet.

Certain aspects relate to the provision of a coding scheme for non-packet data. The coding scheme may be referred to as idle frame signaling. Idle frame signaling may be distinct and non-overlapping with the coding scheme of packet data. Idle frame signaling may include built-in error correction. Idle frame signaling can be used for internal control functions of the link, such as power state signaling, intra- and inter-lane alignment, scrambler operation. Conventional schemes either have fixed ad-hoc coding schemes per function or they need sideband signals if a more generally configurable approach is required.

Certain aspects relate to a systematic method for placing packet data and non-packet data on multiple lanes of a communication link. The number of lanes is not restricted to a fixed number or to a power of 2, and the resulting multi-land communication link that is scalable and adaptable to a wide range of specific use Cases.

### Examples of Processing Circuits and Methods

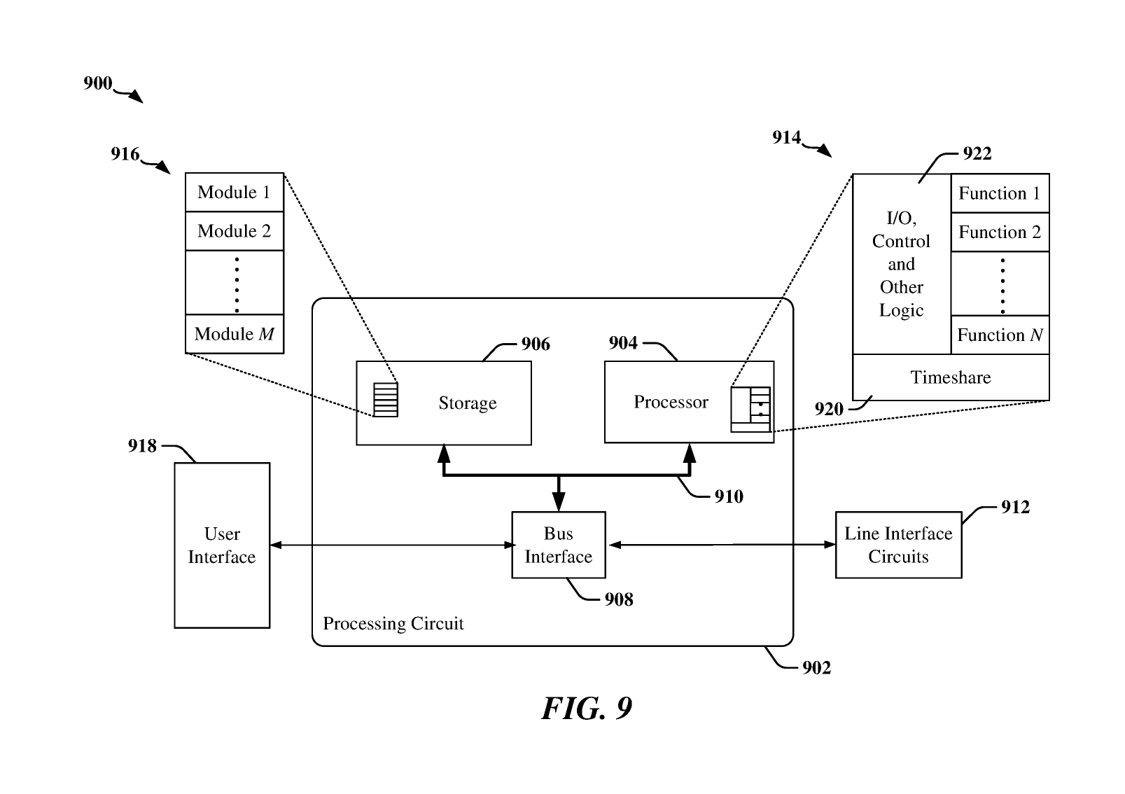

FIG. 9 is a conceptual diagram illustrating a simplified example of a hardware implementation for an apparatus 900 employing a processing circuit 902 that may be configured to perform one or more functions disclosed herein. In accordance with various aspects of the disclosure, an element, or any portion of an element, or any combination of elements as disclosed herein may be implemented using the processing circuit 902. The processing circuit 902 may include one or more processors 904 that are controlled by some combination of hardware and software modules. Examples of processors 904 include microprocessors, microcontrollers, digital signal processors (DSPs), ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 904 may include specialized processors that perform specific functions, and that may be configured, augmented or controlled by one of the software modules 916. The one or more processors 904 may be configured through a combination of software modules 916 loaded during initialization, and further configured by loading or unloading one or more software modules 916 during operation.

In the illustrated example, the processing circuit 902 may be implemented with a bus architecture, represented generally by the bus 910. The bus 910 may include any number of interconnecting buses and bridges depending on the specific application of the processing circuit 902 and the overall design constraints. The bus 910 links together various circuits including the one or more processors 904, and storage 906. Storage 906 may include memory devices and mass storage devices, and may be referred to herein as computer-readable media and/or processor-readable media. The bus 910 may also link various other circuits such as timing sources, timers, peripherals, voltage regulators, and power management circuits. A bus interface 908 may provide an interface between the bus 910 and one or more transceivers 912. A transceiver 912 may be provided for each networking technology supported by the processing circuit. In some instances, multiple networking technologies may share some or all of the circuitry or processing modules found in a transceiver 912. Each transceiver 912 provides a means for communicating with various other apparatus over a transmission medium. Depending upon the nature of the apparatus 900, a user interface 918 (e.g., keypad, display, speaker, microphone, joystick) may also be provided, and may be communicatively coupled to the bus 910 directly or through the bus interface 908.

A processor 904 may be responsible for managing the bus 910 and for general processing that may include the execution of software stored in a computer-readable medium that may include the storage 906. In this respect, the processing circuit 902, including the processor 904, may be used to implement any of the methods, functions and techniques disclosed herein. The storage 906 may be used for storing data that is manipulated by the processor 904 when executing software, and the software may be configured to implement any one of the methods disclosed herein.

One or more processors 904 in the processing circuit 902 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 906 or in an external computer readable medium. The external computer-readable medium and/or storage 906 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 906 may also include, by way of example, a carrier wave, a transmission line, and any other suitable medium for transmitting software and/or instructions that may be accessed and read by a computer. Computer-readable medium and/or the storage 906 may reside in the processing circuit 902, in the processor 904, external to the processing circuit 902, or be distributed across multiple entities including the processing circuit 902. The computer-readable medium and/or storage 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 906 may maintain software maintained and/or organized in loadable code segments, modules, applications, programs, etc., which may be referred to herein as software modules 916. Each of the software modules 916 may include instructions and data that, when installed or loaded on the processing circuit 902 and executed by the one or more processors 904, contribute to a run-time image 914 that controls the operation of the one or more processors 904. When executed, certain instructions may cause the processing circuit 902 to perform functions in accordance with certain methods, algorithms and processes described herein.

Some of the software modules 916 may be loaded during initialization of the processing circuit 902, and these software modules 916 may configure the processing circuit 902 to enable performance of the various functions disclosed herein. For example, some software modules 916 may configure internal devices and/or logic circuits 922 of the processor 904, and may manage access to external devices such as the transceiver 912, the bus interface 908, the user interface 918, timers, mathematical coprocessors, and so on. The software modules 916 may include a control program and/or an operating system that interacts with interrupt handlers and device drivers, and that controls access to various resources provided by the processing circuit 902. The resources may include memory, processing time, access to the transceiver 912, the user interface 918, and so on.

One or more processors 904 of the processing circuit 902 may be multifunctional, whereby some of the software modules 916 are loaded and configured to perform different functions or different instances of the same function. The one or more processors 904 may additionally be adapted to manage background tasks initiated in response to inputs from the user interface 918, the transceiver 912, and device drivers, for example. To support the performance of multiple functions, the one or more processors 904 may be configured to provide a multitasking environment, whereby each of a plurality of functions is implemented as a set of tasks serviced by the one or more processors 904 as needed or desired. In one example, the multitasking environment may be implemented using a timesharing program 920 that passes control of a processor 904 between different tasks, whereby each task returns control of the one or more processors 904 to the timesharing program 920 upon completion of any outstanding operations and/or in response to an input such as an interrupt. When a task has control of the one or more processors 904, the processing circuit is effectively specialized for the purposes addressed by the function associated with the controlling task. The timesharing program 920 may include an operating system, a main loop that transfers control on a round-robin basis, a function that allocates control of the one or more processors 904 in accordance with a prioritization of the functions, and/or an interrupt driven main loop that responds to external events by providing control of the one or more processors 904 to a handling function.

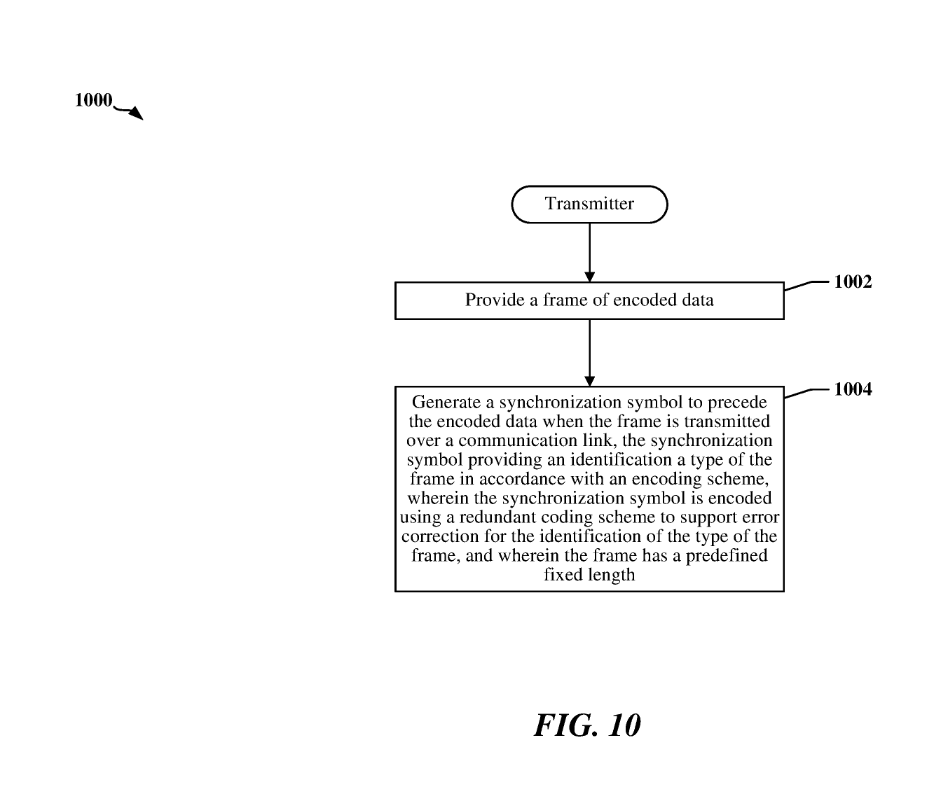

FIG. 10 is a flow chart 1000 of a method of communication using a serial communication link. The method may be performed in the PCS maintained and/or executed on a processing circuit.

At block 1002, a frame of encoded data is provided for transmission. The encoded data may have a length D, and the synchronization symbol has a length S. The value of D may satisfy a condition expressed as D modulo M=0 where M is a natural number. The value of S may satisfy a condition expressed as S+D modulo N=0 where N is a natural number. For example, M=8 and N=10.

At block 1004, a synchronization symbol is generated to precede the encoded data when the frame is transmitted over a communication link. The synchronization symbol may provide an identification of a type of the frame in accordance with an encoding scheme. The synchronization symbol may be encoded using a redundant coding scheme to support error correction for the identification of the type of the frame. The frame may have a predefined fixed length.

In one example, a first data packet is encoded to obtain the frame of encoded data. The first data packet may include a header of fixed length and payload data. The first data packet may include redundant data that provides for data integrity checking of at least a portion of the first data packet. The redundant data may include an error correction code for the header, an error correction code for the payload, and/or a checksum for the payload. The first data packet may be encoded into a number of frames determined based on size of the data packet. A first frame may be indicated as a starting frame of the number of frames using a first type of synchronization symbol. In some instances, one or more frames used to encode the data in addition to the first frame may be indicated as continuation frames using a second type of synchronization symbol that is different from the first type of synchronization symbol.

A high priority second packet may be transmitted after transmission of a first packet has been commenced, and before transmission of the first packet is completed. For example, the first data packet may be encoded into a plurality of frames, and at least one of the plurality of frames may have been transmitted on the communication link. A second data packet carrying low latency or high priority data may be encoded into a prioritized frame, and the prioritized frame may be transmitted before the plurality of frames has been transmitted in its entirety on the communication link. In some instances, the low latency or high priority data may be encoded into a single prioritized frame. The remaining frames of the plurality of frames may be transmitted after the second frame is transmitted.

In some examples, the header includes an identification number indicating a type of the first data packet and metadata associated with the type of the first data packet. The header may indicate that the payload includes configurable metadata. When the configurable metadata is determined to have changed, a second data packet may be encoded into a prioritized frame, the second data packet including the configurable metadata. The prioritized frame may be transmitted as a high-priority frame. In some instances, the second data packet may be encoded into a single prioritized frame.

In some examples, the frame of encoded data is obtained by encoding an ordered bit pattern to obtain a link control frame, and the link control frame may be indicated using a type of synchronization symbol that is different from synchronization symbols used to indicate data packet transmissions. The ordered bit pattern may have a minimum hamming distance of 4. The ordered bit pattern may have at least one of a DC-balanced bit pattern or a high transition density. The ordered bit pattern may provide one or more indications to a receiver. For example, the indications may indicate alignment between a transmitter and the receiver, scrambling status information transmitted on a serial link, and/or a transition between low-power and normal operational states.

In some examples, the communication link includes a plurality of lanes. A first frame of encoded data may be provided for transmission on a first lane of the communication link, where the first frame encoding a first received portion of a data packet to be transmitted on the communication link. A second frame of encoded data may be provided for transmission on a second lane of the communication link, where the second frame encodes a second portion of the data packet that is received immediately after the first portion. The first frame and the second frame may be transmitted concurrently on the communication link. Each subsequent portion of the packet of data may be allocated to a next-in-sequence lane. A third frame of encoded data may be provided for transmission on a third lane of the communication link, where the first frame, the second frame, and the third frame are transmitted concurrently on the communication link.

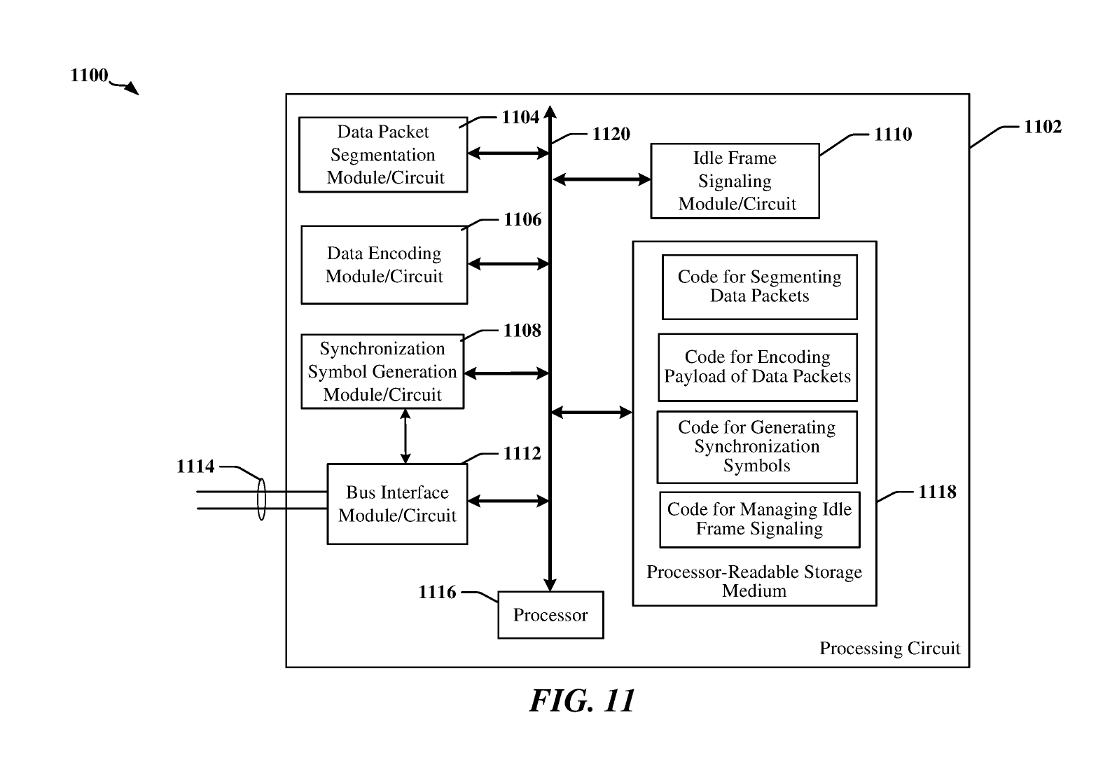

FIG. 11 is a diagram illustrating a simplified example of a hardware implementation for an apparatus 1100 employing a processing circuit 1102. The processing circuit typically has a processor 1116 that may include one or more of a microprocessor, microcontroller, digital signal processor, a sequencer and a state machine. The processing circuit 1102 may be implemented with a bus architecture, represented generally by the bus 1120. The bus 1120 may include any number of interconnecting buses and bridges depending on the specific application of the processing circuit 1102 and the overall design constraints. The bus 1120 links together various circuits including one or more processors and/or hardware modules, represented by the processor 1116, the modules or circuits 1104, 1106, 1108, 1110, line interface circuits 1112 configurable to communicate over connectors or wires 1114 and the computer-readable storage medium 1118. The bus 1120 may also link various other circuits such as timing sources, peripherals, voltage regulators, and power management circuits, which are well known in the art, and therefore, will not be described any further.

The processor 1116 is responsible for general processing, including the execution of software stored on the computer-readable storage medium 1118. The software, when executed by the processor 1116, causes the processing circuit 1102 to perform the various functions described supra for any particular apparatus. The computer-readable storage medium—may also be used for storing data that is manipulated by the processor 1116 when executing software, including data decoded from symbols transmitted over the connectors 1114, which may be configured as data lanes and clock lanes. The processing circuit 1102 further includes at least one of the modules 1104, 1106, 1108, and 1110. The modules 1104, 1106, 1108, and 1110 may be software modules running in the processor 1116, resident/stored in the computer-readable storage medium 1118, one or more hardware modules coupled to the processor 1116, or some combination thereof. The modules 1104, 1106, 1108, and/or 1110 may include microcontroller instructions, state machine configuration parameters, or some combination thereof.

In one configuration, the apparatus 1100 for wireless communication includes a module and/or circuit 1104 that is configured to segment a data packet for encoding in frames to be transmitted on the communication link 1114, a module and/or circuit 1106 configured to encode the data packet in one or more frames, a module and/or circuit 1108 configured to generate synchronization symbols, and a module and/or circuit 1110 configured to generate and/or manage idle frame signaling.

The various modules and/or circuits of the apparatus 1100 may be provided in a transmitting device coupled to a communication link. For example, the transmitting device may include a first encoder configured to encode data in frames, a second encoder configured to generate a synchronization symbol for each frame, the synchronization symbol providing an identification a type of the frame in accordance with an encoding scheme, and a transmitter configured to transmit the frames to a receiver, each frame being preceded by its corresponding synchronization symbol. The synchronization symbol may be encoded using a redundant coding scheme to support error correction for the identification of the type of the frame. The frame may have a predefined fixed length.

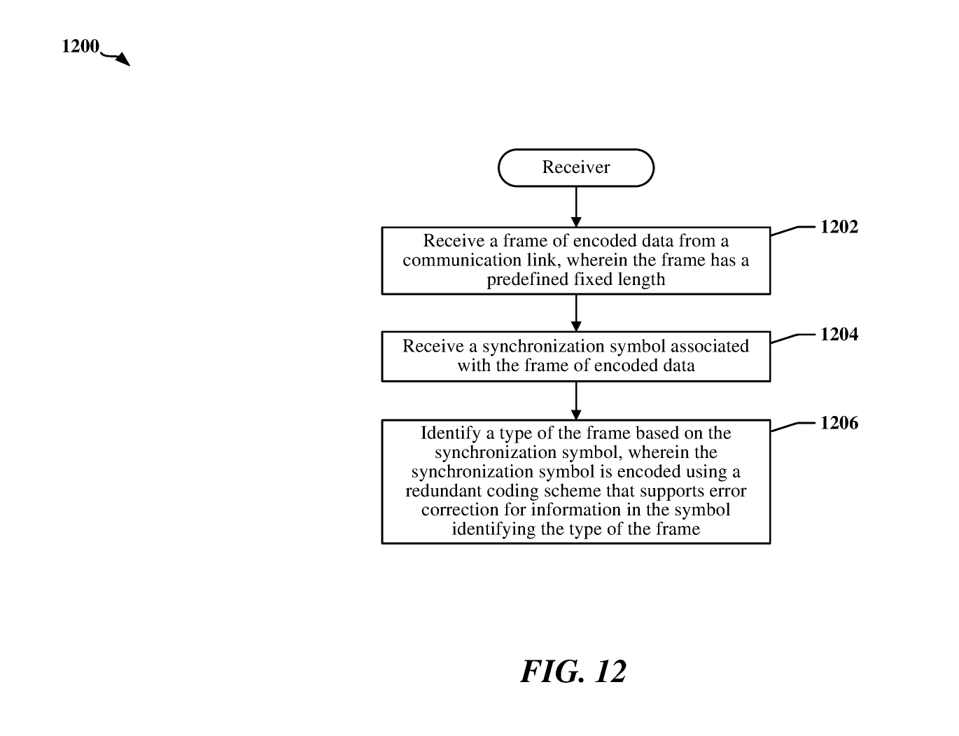

FIG. 12 is a flow chart 1200 of a method of communication using a serial communication link. The method may be performed in the PCS maintained and/or executed on a processing circuit.

At block 1202, a frame of encoded data is received from the communication link. The frame may have a predefined fixed length. The encoded data may have a length D, and the synchronization symbol has a length S. The value of D may satisfy a condition expressed as D modulo M=0 where M is a natural number. The value of S may satisfy a condition expressed as S+D modulo N=0 where N is a natural number. For example, M=8 and N=10.

At block 1204, a synchronization symbol associated with the frame of encoded data may be received from the communication link.

At block 1206, a type of the frame may be identified based on the synchronization symbol. The synchronization symbol may be encoded using a redundant coding scheme that supports error correction for information in the symbol identifying the type of the frame.

In some examples, a first data packet is decoded. The first data packet may include a header of fixed length, and payload data from the frame of encoded data. The first data packet may include redundant data that provides for data integrity checking of at least a portion of the first data packet. The redundant data may include an error correction code for the header, an error correction code for the payload, and/or a checksum for the payload.

In some instances, portions of the first data packet may be decoded from a number of frames determined based on size of the data packet. A first type of synchronization symbol identifies a first frame as a starting frame of the number of frames. A second type of synchronization symbol identifies one or more frames in addition to the first frame as continuation frames, the second type of synchronization symbol being different from the first type of synchronization symbol.

In some instances, at least one of a plurality of frames associated with the first data packet from the communication link may be received before an out-of-sequence frame is received from the communication link, and before all frames associated with the first data packet have been received from the communication link. The out-of-sequence frame may be decoded to obtain a second data packet. The remaining frames of the plurality of frames may be received after the out-of-sequence frame is received and/or decoded.

In some instances, payload data may be decoded from the frame of encoded data when the header includes an identification number indicating that the first data packet is a high-priority packet.

In some instances, the frame of encoded data includes an ordered bit pattern. The ordered bit pattern may indicate alignment between a transmitter and the receiver, scrambling status information, and/or a transition between low-power and normal operational states. The ordered bit pattern may have a minimum hamming distance of 4. The ordered bit pattern may include a DC-balanced bit pattern and/or a high transition density.

In some examples, the communication link has a plurality of lanes. A first frame of encoded data may be received from a first lane of the communication link, where the first frame encodes a first received portion of a data packet to be transmitted on the communication link. A second frame of encoded data may be received from a second lane of the communication link, where the second frame encodes a second portion of the data packet that is received immediately after the first portion. The first frame and the second frame may be transmitted concurrently on the communication link. Each subsequent portion of the packet of data may be received from a next-in-sequence lane.

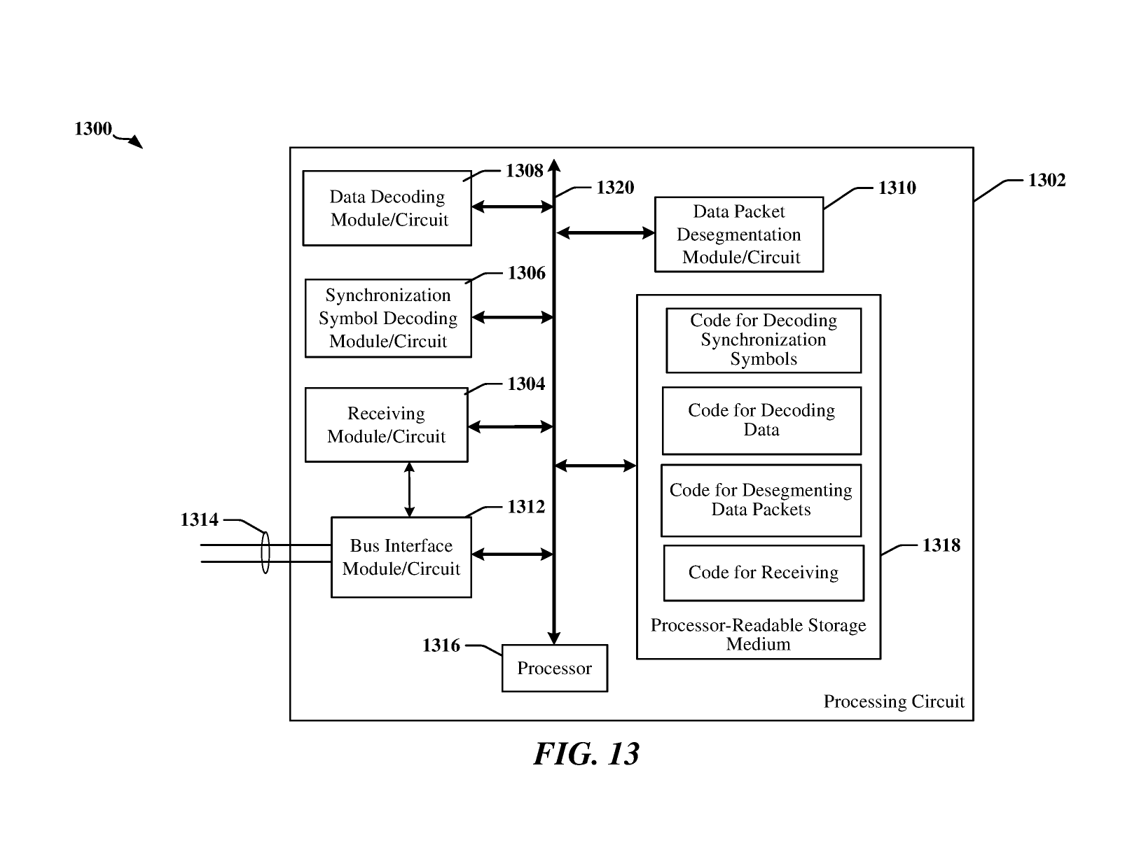

FIG. 13 is a diagram illustrating a simplified example of a hardware implementation for an apparatus 1300 employing a processing circuit 1302. The processing circuit typically has a processor 1316 that may include one or more of a microprocessor, microcontroller, digital signal processor, a sequencer and a state machine. The processing circuit 1302 may be implemented with a bus architecture, represented generally by the bus 1320. The bus 1320 may include any number of interconnecting buses and bridges depending on the specific application of the processing circuit 1302 and the overall design constraints. The bus 1320 links together various circuits including one or more processors and/or hardware modules, represented by the processor 1316, the modules or circuits 1304, 1306, 1308, 1310, line interface circuits 1312 configurable to communicate over connectors or wires 1314 and the computer-readable storage medium 1318. The bus 1320 may also link various other circuits such as timing sources, peripherals, voltage regulators, and power management circuits, which are well known in the art, and therefore, will not be described any further.

The processor 1316 is responsible for general processing, including the execution of software stored on the computer-readable storage medium 1318. The software, when executed by the processor 1316, causes the processing circuit 1302 to perform the various functions described supra for any particular apparatus. The computer-readable storage medium 1318 may also be used for storing data that is manipulated by the processor 1316 when executing software, including data decoded from symbols transmitted over the connectors 1314, which may be configured as data lanes and clock lanes. The processing circuit 1302 further includes at least one of the modules 1304, 1306, 1308, and 1310. The modules 1304, 1306, 1308, and 1310 may be software modules running in the processor 1316, resident/stored in the computer-readable storage medium 1318, one or more hardware modules coupled to the processor 1316, or some combination thereof. The modules 1304, 1306, 1308, and/or 1310 may include microcontroller instructions, state machine configuration parameters, or some combination thereof.

In one configuration, the apparatus 1300 for wireless communication includes a module and/or circuit 1304 that is configured to receive data frames from the communication link 1314, a module and/or circuit 1306 configured to decode synchronization symbols received from the communication link, a module and/or circuit 1308 configured to decode data from frames received from the communication link, and a module and/or circuit 1310 configured to build and/or desegment data packets from frames received from the communication link.

The various modules and/or circuits of the apparatus 1300 may be provided in a receiving device coupled to a communication link. For example, the receiving device may include a receiver configured to receive one or more frames from a transmitter using the communication link, each frame being preceded by a corresponding synchronization symbol, a first decoder configured to decode synchronization symbols that precede the frames, each synchronization symbol providing an identification a type of its corresponding frame in accordance with an encoding scheme, and a second decoder configured to decode data from each frame based on information provided by a corresponding synchronization symbol. The synchronization symbol may be encoded using a redundant coding scheme to support error correction for the identification of the type of the frame. The frame may have a predefined fixed length.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method performed at a physical layer of a communication interface, comprising:
providing a frame of encoded data; and
generating a synchronization symbol to precede the encoded data when the frame is transmitted over a communication link, the synchronization symbol providing an identification of a type of the frame in accordance with an encoding scheme,
wherein the synchronization symbol is encoded using a redundant coding scheme to support error correction for the identification of the type of the frame, and
wherein the frame has a predefined fixed length.

2. The method of claim 1, wherein the encoded data has a length D, wherein the synchronization symbol has a length S, and wherein D has a value that satisfies a condition expressed as D modulo M=0 where M is a natural number, and S has a value that satisfies a condition expressed as S+D modulo N=0 where N is a natural number.

3. The method of claim 2, wherein M=8 and N=10.

4. The method of claim 1, further comprising:
encoding a first data packet that includes a header of fixed length, and payload data to obtain the frame of encoded data.

5. The method of claim 4, wherein the first data packet includes redundant data that provides for data integrity checking of at least a portion of the first data packet.

6. The method of claim 5, wherein the redundant data includes at least one of an error correction code for the header, an error correction code for the payload, or a checksum for the payload.

7. The method of claim 4, wherein encoding the first data packet comprises:
encoding the first data packet into a number of frames determined based on size of the data packet;
indicating a first frame as a starting frame of the number of frames using a first type of synchronization symbol; and
indicating the one or more frames as continuation frames using a second type of synchronization symbol that is different from the first type of synchronization symbol when one or more frames in addition to the first frame are used to encode the data frame.

8. The method of claim 4, wherein encoding the first data packet comprises:
encoding the first data packet into a plurality of frames;
transmitting at least one of the plurality of frames on the communication link;
encoding a second data packet into a prioritized frame, the second data packet comprising low latency or high priority data;
transmitting the prioritized frame before the plurality of frames has been transmitted in its entirety on the communication link; and
transmitting remaining frames of the plurality of frames after transmitting the second frame.

9. The method of claim 4, wherein the header includes an identification number indicating a type of the first data packet and metadata associated with the type of the first data packet.

10. The method of claim 9, wherein the header indicates that the payload includes configurable metadata, and further comprising:
determining that the configurable metadata has changed;
encoding a second data packet into a single prioritized frame, the second data packet comprising the configurable metadata; and
transmitting the single prioritized frame as a high-priority frame.

11. The method of claim 1, wherein providing the frame of encoded data comprises:
encoding an ordered bit pattern to obtain a link control frame; and
indicating the link control frame using a type of synchronization symbol that is different from synchronization symbols used to indicate data packet transmissions.

12. The method of claim 11, wherein the ordered bit pattern has a minimum hamming distance of 4, and comprises at least one of a DC-balanced bit pattern or a high transition density.

13. The method of claim 11, wherein the ordered bit pattern provides one or more indications to a receiver, the one or more indications including at least one of alignment between a transmitter and the receiver, scrambling status information transmitted on a serial link, or a transition between low-power and normal operational states.

14. The method of claim 1, wherein the communication link comprises a plurality of lanes, and wherein providing the frame of encoded data comprises:
providing a first frame of encoded data for transmission on a first lane of the communication link, the first frame encoding a first received portion of a data packet to be transmitted on the communication link; and
providing a second frame of encoded data for transmission on a second lane of the communication link, the second frame encoding a second portion of the data packet that is received immediately after the first portion,
wherein the first frame and the second frame are transmitted concurrently on the communication link, and
wherein each subsequent portion of the data packet is allocated to a next-in-sequence lane.

15. The method of claim 14, wherein providing the frame of encoded data comprises:
providing a third frame of encoded data for transmission on a third lane of the communication link,
wherein the first frame, the second frame, and the third frame are transmitted concurrently on the communication link.

16. An apparatus adapted to be coupled to a communication link, comprising:
a first encoder configured to encode data in frames;
a second encoder configured to generate a synchronization symbol for each frame, the synchronization symbol providing an identification a type of the frame in accordance with an encoding scheme; and
a transmitter configured to transmit the frames to a receiver, each frame being preceded by its corresponding synchronization symbol,
wherein the synchronization symbol is encoded using a redundant coding scheme to support error correction for the identification of the type of the frame, and
wherein the frame has a predefined fixed length.

17. The apparatus of claim 16, wherein the data encoded in the frames has a length D, wherein the synchronization symbol has a length S, and wherein D has a value that satisfies a condition expressed as D modulo M=0 where M is a natural number, and S has a value that satisfies a condition expressed as S+D modulo N=0 where N is a natural number.

18. A method performed at a physical layer of a communication interface in a receiving device, comprising:
receiving a frame of encoded data from a communication link, wherein the frame has a predefined fixed length;
receiving a synchronization symbol associated with the frame of encoded data; and
identifying a type of the frame based on the synchronization symbol,
wherein the synchronization symbol is encoded using a redundant coding scheme that supports error correction for information in the symbol identifying the type of the frame.

19. The method of claim 18, wherein the encoded data has a length D, wherein the synchronization symbol has a length S, and wherein D has a value that satisfies a condition expressed as D modulo M=0 where M is a natural number, and S has a value that satisfies a condition expressed as S+D modulo N=0 where N is a natural number.

20. The method of claim 19, wherein M=8 and N=10.

21. The method of claim 18, further comprising:
decoding a first data packet that includes a header of fixed length, and payload data from the frame of encoded data, wherein the first data packet includes redundant data that provides for data integrity checking of at least a portion of the first data packet.

22. The method of claim 21, wherein the redundant data includes at least one of an error correction code for the header, an error correction code for the payload, or a checksum for the payload.

23. The method of claim 21, wherein decoding the first data packet comprises:
decoding portions of the first data packet from a number of frames determined based on size of the data packet,
wherein a first type of synchronization symbol identifies a first frame as a starting frame of the number of frames, and
wherein a second type of synchronization symbol identifies one or more frames in addition to the first frame as continuation frames, the second type of synchronization symbol being different from the first type of synchronization symbol.

24. The method of claim 21, wherein decoding the first data packet comprises:
receiving at least one of a plurality of frames associated with the first data packet from the communication link;
receiving an out-of-sequence frame from the communication link before all frames associated with the first data packet have been received from the communication link;
decoding the out-of-sequence frame to obtain a second data packet; and
receiving remaining frames of the plurality of frames after decoding the out-of-sequence frame.

25. The method of claim 21, and further comprising:
decoding payload data from the frame of encoded data when the header includes an identification number indicating that the first data packet is a high-priority packet.

26. The method of claim 18, wherein the frame of encoded data comprises an ordered bit pattern, and wherein the ordered bit pattern indicates at least one of alignment between a transmitter and the receiver, scrambling status information, or a transition between low-power and normal operational states.

27. The method of claim 26, wherein the ordered bit pattern has a minimum hamming distance of 4, and comprises at least one of a DC-balanced bit pattern or a high transition density.

28. The method of claim 18, wherein the communication link comprises a plurality of lanes, and wherein receiving a frame of encoded data comprises:
receiving a first frame of encoded data from a first lane of the communication link, the first frame encoding a first received portion of a data packet to be transmitted on the communication link; and
receiving a second frame of encoded data from a second lane of the communication link, the second frame encoding a second portion of the data packet that is received immediately after the first portion,
wherein the first frame and the second frame are received concurrently from the communication link, and
wherein each subsequent portion of the data packet is received from a next-in-sequence lane.

29. An apparatus adapted to be coupled to a communication link, comprising:
a receiver configured to receive one or more frames from a transmitter using the communication link, each frame being preceded by a corresponding synchronization symbol;
a first decoder configured to decode synchronization symbols that precede the frames, each synchronization symbol providing an identification a type of its corresponding frame in accordance with an encoding scheme; and
a second decoder configured to decode data from each frame based on information provided by a corresponding synchronization symbol,
wherein the synchronization symbol is encoded using a redundant coding scheme to support error correction for the identification of the type of the frame, and
wherein the frame has a predefined fixed length.

30. The apparatus of claim 29, wherein the data encoded in the frames has a length D, wherein the synchronization symbol has a length S, and wherein D has a value that satisfies a condition expressed as D modulo M=0 where M is a natural number, and S has a value that satisfies a condition expressed as S+D modulo N=0 where N is a natural number.
